(19) United States
(12) Patent Application Publication
(10) Pub. No.: US 2025/0165845 A1
(43) Pub. Date: May 22, 2025

(54) ERROR LIMITING PROTOCOL FOR THE CONSTRUCTION OF TWO-QUBIT GATES IN AN ION-TRAP QUANTUM COMPUTING SYSTEM

(71) Applicant: IONQ, INC., College Park, MD (US)

(72) Inventors: Reinhold BLUMEL, Middletown, CT (US); Andrii MAKSYMOV, Hyattsville, MD (US); Ming LI, Silver Spring, MD (US)

(21) Appl. No.: 18/951,410

(22) Filed: Nov. 18, 2024

Related U.S. Application Data
(60) Provisional application No. 63/601,783, filed on Nov. 22, 2023.

(51) Int. Cl. G06N 10/70; G06N 10/60

(52) U.S. Cl. CPC G06N 10/70; G06N 10/60

(57) ABSTRACT

A method of performing a two-qubit gate operation includes computing, by a classical computer, a control pulse to be applied to a pair of trapped ions in a plurality of trapped ions in a quantum processor, each of the plurality of trapped ions having two frequency-separated states defining a qubit, wherein computing the control pulse comprises: computing a pulse function of the control pulse based on a phase-space closure condition and an auxiliary condition, and computing the pulse function of the control pulse further based on a gate angle condition, and applying, by a system controller, the control pulse, having the computed pulse function, to the pair of trapped ions.

### CROSS-REFERENCE TO RELATED APPLICATIONS

This application claims priority to U.S. Provisional Application Ser. No. 63/601,783 filed Nov. 22, 2023, which is herein incorporated by reference in its entirety.

### BACKGROUND

### Field

The present disclosure generally relates to a method of performing computations in a quantum computing system, and more specifically, to a method of constructing two-qubit gate operations in a quantum computing system that includes a chain of trapped ions.

### Description of the Related Art

Among physical systems upon which it is proposed to build large-scale quantum computers, is a chain of ions (i.e., charged atoms), which are trapped and suspended in vacuum by electromagnetic fields. The ions have internal hyperfine states which are separated by frequencies in the several GHz range and can be used as the computational states of a qubit (referred to as “qubit states”). These hyperfine states can be controlled using radiation provided from a laser, or sometimes referred to herein as the interaction with laser beams. The ions can be cooled to near their motional ground states using such laser interactions. The ions can also be optically pumped to one of the two hyperfine states with high accuracy (preparation of qubits), manipulated between the two hyperfine states (single-qubit gate operations) by laser beams, and their internal hyperfine states detected by fluorescence upon application of a resonant laser beam (read-out of qubits). A pair of ions can be controllably entangled (two-qubit gate operations) by a qubit-state dependent force using laser pulses that couple the ions to the collective motional modes of a chain of trapped ions, which arise from the Coulombic interaction between the ions. In general, entanglement occurs when pairs or chains of ions (or particles) are generated, interact, or share spatial proximity in ways such that the quantum state of each ion cannot be described independently of the quantum state of the others, even when the ions are separated by a large distance.

Realistic fault-tolerant quantum computing at reasonable overhead requires two-qubit gates with the highest possible fidelity, typically an infidelity of ≤10⁻⁴. However, in a commonly used phase-sensitive architecture, even under noise-free ideal conditions, control pulses constructed by conventional methods do not provide Mølmer-Sørensen XX gates based on the Raman scheme with an infidelity of ≤10⁻⁴.

Therefore, there is a need for a method of constructing gate operations with respect to the parameter drifts or fluctuations within an acceptable error in quantum computation.

### SUMMARY

Embodiments of the present disclosure provide a method of performing a two-qubit gate operation. The method includes computing, by a classical computer, a control pulse to be applied to a pair of trapped ions in a plurality of trapped ions in a quantum processor, each of the plurality of trapped ions having two frequency-separated states defining a qubit, wherein computing the control pulse comprises computing a pulse function of the control pulse based on a phase-space closure condition and an auxiliary condition, and computing the pulse function of the control pulse further based on a gate angle condition, and applying, by a system controller, the control pulse, having the computed pulse function, to the pair of trapped ions.

Embodiments of the present disclosure also provide a quantum computing system. The quantum computing system includes a quantum processor comprising a plurality of trapped ions, wherein each of the trapped ions having two frequency-separated states defining a qubit, a classical computer configured to compute a control pulse to be applied to a pair of trapped ions in the quantum processor, wherein computing the control pulse comprises computing a pulse function of the control pulse based on a phase-space closure condition and an auxiliary condition, and computing the pulse function of the control pulse further based on a gate angle condition, and a system controller configured to apply the control pulse, having the computed pulse function, to the pair of trapped ions.

Embodiments of the present disclosure further provide a quantum computing system. The quantum computing system includes non-volatile memory having a number of instructions stored therein which, when executed by one or more processors, causes the quantum computing system to perform operations comprising computing, by a classical computer, a control pulse to be applied to a pair of trapped ions in a plurality of trapped ions in a quantum processor, each of the plurality of trapped ions having two frequency-separated states defining a qubit, wherein computing the control pulse comprises computing a pulse function of the control pulse based on a phase-space closure condition and an auxiliary condition, and computing the pulse function of the control pulse further based on a gate angle condition, and applying, by a system controller, the control pulse, having the computed pulse function, to the pair of trapped ions.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to aspects of this disclosure.

FIG. 2 depicts a schematic view of an ion trap for confining ions in a chain according to aspects of this disclosure.

FIG. 3 depicts a schematic energy diagram of each ion in a chain of trapped ions according to aspects of this disclosure.

FIG. 4 depicts a qubit state of an ion represented as a point on the surface of the Bloch sphere.

FIGS. 5A, 5B, and 5C depict a few schematic collective transverse motional mode structures of a chain of five trapped ions.

FIGS. 6A and 6B depict schematic views of a motional sideband spectrum of each ion and a motional mode according to aspects of this disclosure.

FIG. 7 depicts the relationship between a hardware-implemented quantum computer (REALITY, governed by the Hamiltonian Ĥ_{R}), the corresponding model quantum computer (MODEL, governed by the model Hamiltonian Ĥ_{M}) and the control pulses (CONTROL, constructed on the basis of the control Hamiltonian Ĥ_{C}) that control both the actual hardware-implemented quantum computer (REALITY) and the model quantum computer (MODEL).

FIG. 8 depicts a number of gates vs. Φ-infidelity for N=36 ions, uncalibrated, τ=300 μs AMFM pulses, not requiring the Φ condition. The infidelities are in units of 10⁻¹.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Embodiments described herein are generally related to a method of performing a computation in a quantum computing system, and more specifically, to a method of constructing control pulses that implement entangling gates in a quantum computing system that includes a chain of trapped ions. The method can include a process of constructing the control pulses that implement stabilized entangling gate operations used in the computational process performed by a quantum computing system.

Embodiments of the disclosure include a quantum computing system that is able to perform a quantum computation process by use of a classical computer, a system controller, and a quantum processor. The classical computer performs supporting tasks including selecting a quantum algorithm to be used, computing quantum circuits to run the quantum algorithm, and outputting results of the execution of the quantum circuits by use of a user interface. A software program for performing the tasks is stored in a non-volatile memory within the classical computer. The quantum processor includes trapped ions that are coupled with various hardware, including lasers to manipulate internal hyperfine states (qubit states) of the trapped ions and photomultiplier tubes (PMTs) to read-out the internal hyperfine states (qubit states) of the trapped ions. The system controller receives from the classical computer instructions for controlling the quantum processor, and controls various hardware associated with controlling any and all aspects used to run the instructions for controlling the quantum processor, and transmits a read-out of the quantum processor and thus output of results of the read-out to the classical computer. In some embodiments, the classical computer will then utilize the computational results based on the output of results of the read-out to form a results-set that is then provided to a user in the form of results displayed on a user interface, stored in a memory and/or transferred to another computational device for solving technical problems.

In Section III, various Hamiltonians used in gate construction and error analysis are shown. In Section IV, construction methods, focusing on the AMFM pulse-construction method that are used for generating test pulses are discussed. In Section V, a gate-simulation method is shown, which propagates an initial state |ψ(t=0)> into a final state |ψ(τ)>, where τ is the gate time, including the 2-qubit computational space and a portion of the phonon space large enough to obtain converged results. In Section VI, various fidelity measures are defined that are used to assess the quality of various Hamiltonians used to construct XX gates. In Section VII, numerical simulation results are shown. In Section VIII, a simple pulse-scaling method (calibration) is shown that may be used to eliminate coherent errors that result in XX gates that deviate from the target degree of entanglement. In Section IX, sources of errors that are incurred by a general pulse function g(t) are analyzed. This Method may be used in particular for a pulse function g(t) constructed on the basis of the standard Hamiltonian to control a quantum computer assumed to be governed by the full Mølmer-Sørensen Hamiltonian. The analysis is conducted analytically, and error integrals are evaluated numerically to assess error magnitudes. In Section X, a linear method of eliminating an important class of coherent errors are presented. It is this method, together with pulse calibration that allows us to suppress coherent XX gate errors to the level of ≤10⁻¹. In Section XI, the scaling of the results to the case of chains consisting of 32 ions is discussed.

### I. General Hardware Configurations

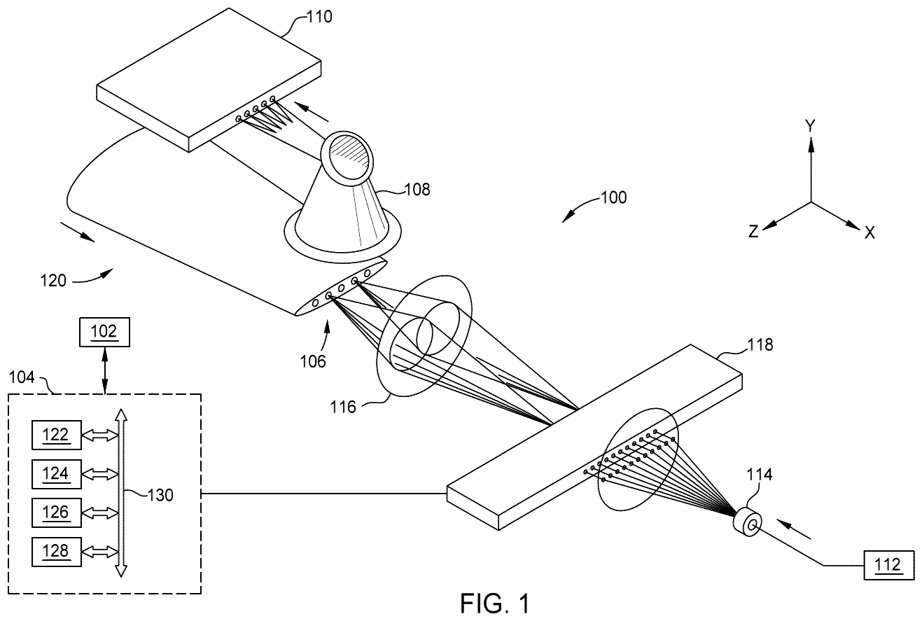

FIG. 1 is a schematic partial view of an ion trap quantum computing system according to one embodiment. The ion trap quantum computing system 100 includes a classical (digital) computer 102, a system controller 104 and a quantum processor that is a chain 106 of trapped ions (i.e., five shown) that extend along the Z-axis. Each ion in the chain 106 of trapped ions is an ion having a nuclear spin I and an electron spin S such that a difference between the nuclear spin I and the electron spin S is zero, such as a positive ytterbium ion, ¹⁷¹Yb⁺, a positive barium ion ¹³³Ba⁺, a positive cadmium ion ¹¹¹Cd⁺ or ¹¹³Cd⁺, which all have a nuclear spin

$$I = \frac{1}{2}$$

and the ²S_{1/2} hyperfine states. In some embodiments, all ions in the chain 106 of trapped ions are the same species and isotope (e.g., ¹⁷¹Yb⁺). In some other embodiments, the chain 106 of trapped ions includes one or more species or isotopes (e.g., some ions are ¹⁷¹Yb⁺ and some other ions are ¹³³Ba⁺). In yet additional embodiments, the chain 106 of trapped ions may include various isotopes of the same species (e.g., different isotopes of Yb, different isotopes of Ba). The ions in the chain 106 of trapped ions are individually addressed with separate laser beams. The classical computer 102 includes a central processing unit (CPU), memory, and support circuits (or I/O). The memory is connected to the CPU, and may be one or more of a readily available memory, such as a read-only memory (ROM), a random-access memory (RAM), floppy disk, hard disk, or any other form of digital storage, local or remote. Software instructions, algorithms and data can be coded and stored within the memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 is configured to illuminate all ions simultaneously. In some embodiments, individual Raman laser beams (not shown) each illuminate individual ions. The system controller (also referred to as a “RF controller”) 104 controls the AOM 118 and thus controls laser pulses to be applied to trapped ions in the chain 106 of trapped ions. The system controller 104 includes a central processing unit (CPU) 122, a read-only memory (ROM) 124, a random-access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by a processor in order to perform various functionalities associated with receiving and analyzing data and controlling any and all aspects of the methods and hardware used to create the ion trap quantum computer system 100 discussed herein.

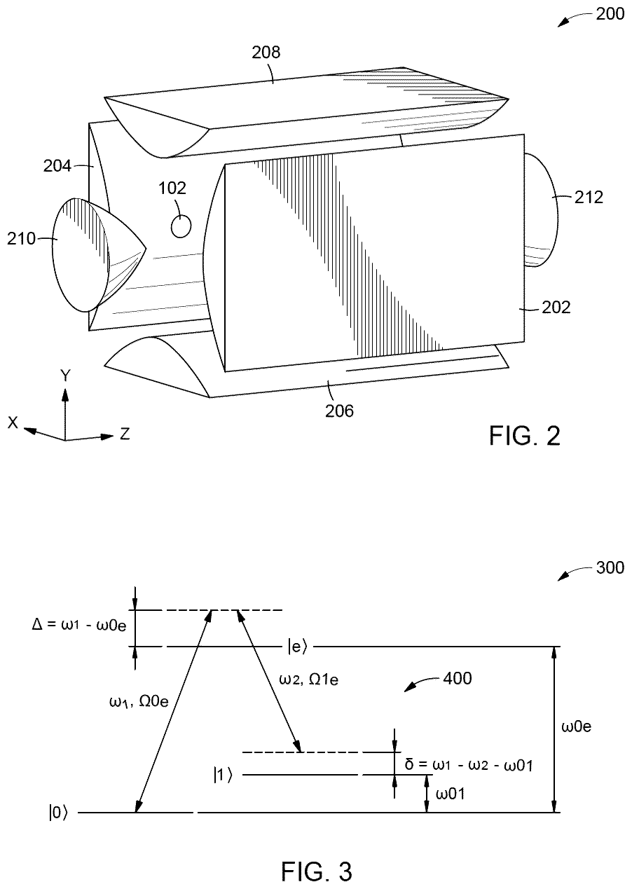

FIG. 2 depicts a schematic view of an ion trap 200 (also referred to as a Paul trap) for confining ions in the chain 106 according to one embodiment. The confining potential is exerted by both a static (DC) voltage and a radio frequency (RF) voltage. A static (DC) voltage is applied to end-cap electrodes 210 and 212 to confine the ions along the Z-axis (also referred to as an “axial direction” or a “longitudinal direction”). The ions in the chain 106 are nearly evenly spaced in the axial direction due to the Coulomb interaction between the ions. In some embodiments, the ion trap 200 includes four hyperbolically shaped electrodes 202, 204, 206, and 208 extending along the Z-axis.

During operation, a sinusoidal voltage V₁ (with an amplitude V_{RF}/2) is applied to an opposing pair of electrodes 202, 204 and a sinusoidal voltage V₂ with a phase shift of 180° from the sinusoidal voltage V₁ (and the amplitude V_{RF}/2) is applied to the other opposing pair of electrodes 206, 208 at a driving frequency ω_{RF}, generating a quadrupole potential. In some embodiments, a sinusoidal voltage is only applied to one opposing pair of electrodes 202, 204, and the other opposing pair 206, 208 is grounded. The quadrupole potential creates an effective confining force in the X-Y plane perpendicular to the Z-axis (also referred to as a “radial direction” or “transverse direction”) for each of the trapped ions, which is proportional to the distance from a saddle point (i.e., a position in the axial direction (Z-direction)) at which the RF electric field vanishes. The motion in the radial direction (i.e., direction in the X-Y plane) of each ion is approximated as a harmonic oscillation (referred to as secular motion) with a restoring force towards the saddle point in the radial direction and can be modeled by spring constants kₓ and k_{y}, respectively. In some embodiments, the spring constants in the radial direction are modeled as equal when the quadrupole potential is symmetric in the radial direction. However, undesirably in some cases, the motion of the ions in the radial direction may be distorted due to some asymmetry in the physical trap configuration, a small DC patch potential due to inhomogeneity of a surface of the electrodes, or the like and due to these and other external sources of distortion the ions may lie off-center from the saddle points. The Paul trap described herein is just one example of the types of traps that can be used as the ion trap 200. Other types of traps, including surface traps, can also be used for this purpose although their operation may be somewhat different.

FIG. 3 depicts a schematic energy diagram 300 of each ion in the chain 106 of trapped ions according to one embodiment. Each ion in the chain 106 of trapped ions is an ion having a nuclear spin I and an electron spin S such that a difference between the nuclear spin I and the electron spin is zero. In one example, each ion may be a positive Ytterbium ion ¹⁷¹Yb⁺, which has a nuclear spin

$$I = \frac{1}{2}$$

and the ²S_{1/2} hyperfine states (i.e., a multiplet of electronic states of which two are used as computational states) with an energy split corresponding to a frequency difference (referred to as a “carrier frequency”) of ω₀₁/2π=12.642812 GHz. In other examples, each ion may be a positive barium ion ¹³³Ba⁺, a positive cadmium ion ¹¹¹Cd⁺ or ¹¹³Cd⁺, which all have a nuclear spin

$$I = \frac{1}{2}$$

and the ²S_{1/2} hyperfine states. A qubit is formed with two hyperfine states, denoted as |d [symbol] and |1 [symbol] , where the hyperfine ground state (i.e., the lowest energy state of the ²S_{1/2} hyperfine states) is chosen to represent |0 [symbol] . Hereinafter, the terms “hyperfine states”, “internal hyperfine states”, and “qubit states” may be interchangeably used to represent |0 [symbol] and |1 [symbol] . Further, the terms “trapped ions,” “ions,” and “qubits” may be interchangeably used. Each ion may be cooled (i.e., the kinetic energy of the ion may be reduced) to near the motional ground state |0 [symbol] ₚ for any motional mode with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₚ with the subscript denotes the motional ground state for a motional mode p of a chain 106 of trapped ions.

An individual qubit state of each trapped ion may be manipulated by, for example, a mode-locked laser at 355 nanometers (nm) via the excited ²P_{1/2} level (denoted as |e [symbol] ). As shown in FIG. 3, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀ₑ between |0 [symbol] and |e [symbol] , as illustrated in FIG. 3. A two-photon transition detuning frequency δ includes adjusting the amount of energy that is provided to the trapped ion by the first and second laser beams, which, when combined, is used to cause the trapped ion to transfer between the hyperfine states |0 [symbol] and |1 [symbol] . When the one-photon transition detuning frequency Δ is much larger than the two-photon transition detuning frequency (also referred to simply as “detuning frequency”) δ=ω₁−ω₂−ω₀₁ (hereinafter denoted as ±μ, μ being a positive value), the single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and the spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman A configuration to manipulate internal hyperfine states of qubits (qubit states) may be referred to as a “composite pulse” or simply as a “pulse,” described by a pulse function g(t) and the resulting time-dependent pattern of the two-photon Rabi frequency Ω(t) may be referred to as an “amplitude” of a pulse. The detuning frequency δ=ω₁−ω₂−ω₀₁ may be referred to as the detuning frequency of the composite pulse or the detuning frequency of the pulse. The amplitude of the two-photon Rabi frequency Ω(t), which is determined by amplitudes of the first and second laser beams, may be referred to as an “amplitude” of the composite pulse, such that the pulse function g(t) is now represented as

$$g ( t ) = Ω ( t ) sin \{ {\int }_{0}^{t} μ ( {t}^{′} ) {dt}^{′} + φ ( t ) \} ,$$

where φ(t) is a “phase” of the composite pulse that may be time dependent.

It should be noted that the particular atomic species used in the discussion provided herein is just one example of atomic species which have stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg⁺, and Ba⁺) or transition metal ions (Zn⁺, Hg⁺, Cd⁺).

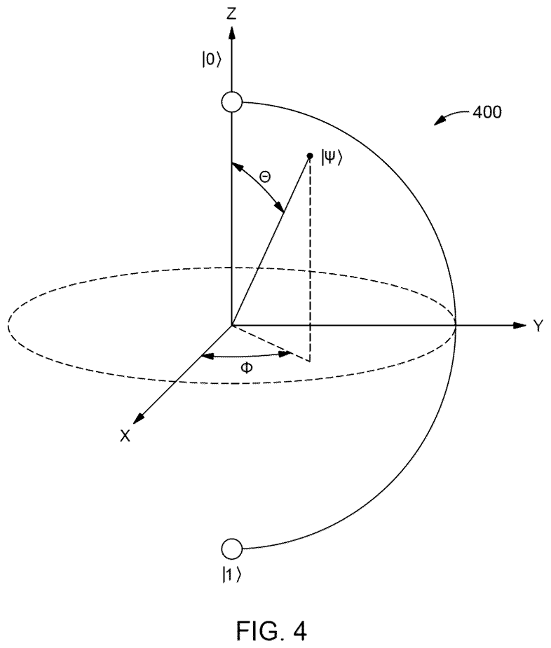

FIG. 4 is provided to help visualize a qubit state of an ion represented as a point on the surface of the Bloch sphere 400 with an azimuthal angle ϕ and a polar angle θ. Application of the composite pulse as described above, causes Rabi flopping between the qubit state |0 [symbol] (represented as the north pole of the Bloch sphere) and |1 [symbol] (the south pole of the Bloch sphere) to occur. Adjusting time duration and the composite pulse flips the qubit state from |0 [symbol] to |1 [symbol] (i.e., from the north pole to the south pole of the Bloch sphere), or the qubit state from |1 [symbol] to |0 [symbol] (i.e., from the south pole to the north pole of the Bloch sphere). This application of the composite pulse is referred to as a “π-pulse”, Further, by adjusting time duration and the composite pulse, the qubit state |0 [symbol] may be transformed to a superposition state |0 [symbol] +1 [symbol] , where the two qubit-states |0 [symbol] and |1 [symbol] are added and equally-weighted in-phase (a normalization factor of the superposition state is omitted hereinafter for convenience) and the qubit state |1 [symbol] to a superposition state |0 [symbol] -|1 [symbol] , where the two qubit-states |0 [symbol] and |1 [symbol] are added equally-weighted but out of phase. This application of the composite pulse is referred to as a “π/2-pulse”. More generally, a superposition of the two qubit-states |0 [symbol] and |1 [symbol] that are added and equally weighted is represented by a point that lies on the equator of the Bloch sphere. For example, the superposition states |0 [symbol] ±|1 [symbol] correspond to points on the equator with the azimuthal angle ϕ being zero and π, respectively. The superposition states that correspond to points on the equator with the azimuthal angle ϕ are denoted as |0 [symbol] +e^{iϕ}|1 [symbol] . Transformation between two points on the equator (i.e. a rotation about the Z-axis on the Bloch sphere) can be implemented by shifting phases of the composite pulse.

### II. Entanglement Formation

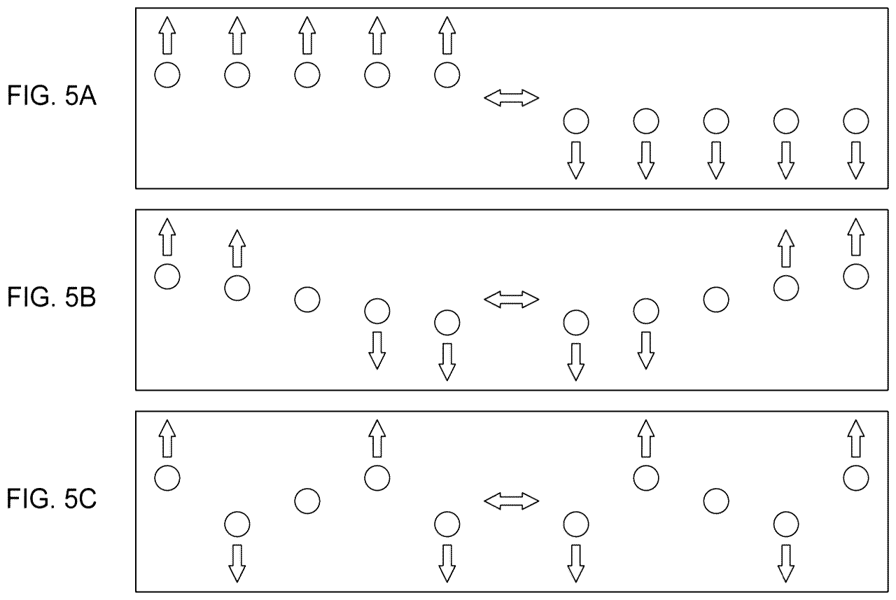

FIGS. 5A, 5B, and 5C depict a few schematic structures of collective transverse motional modes (also referred to simply as “motional mode structures”) of a chain 106 of five trapped ions, for example. Here, the confining potential due to a static voltage V_{S} applied to the end-cap electrodes 210 and 212 is weaker compared to the confining potential in the radial direction. The collective motional modes of the chain 106 of trapped ions in the transverse direction are determined by the Coulomb interaction between the trapped ions combined with the confining potentials generated by the ion trap 200. The trapped ions undergo collective transversal motions (referred to as “collective transverse motional modes,” “collective motional modes,” or simply “motional modes”), where each mode has a distinct energy (or equivalently, a frequency) associated with it. A motional mode having the p-th lowest frequency is hereinafter referred to as |nₚₕ [symbol] ₚ, where nₚₕ denotes the number of motional quanta (in units of energy excitation, referred to as phonons) in the motional mode, and the number of motional modes P in a given transverse direction is equal to the number of trapped ions N in the chain 106. FIGS. 5A-5C schematically illustrate examples of different types of collective transverse motional modes that may be experienced by five trapped ions that are positioned in a chain 106. FIG. 5A is a schematic view of the common motional mode P having the highest energy where P is the number of motional modes. In the common motional mode |nₚₕ [symbol] _{P}, all ions oscillate in phase in the transverse direction. FIG. 5B is a schematic view of the tilt motional mode |nₚₕ [symbol] _{P-1} which has the second highest energy. In the tilt motional mode, ions on opposite ends move out of phase in the transverse direction (i.e., in opposite directions). FIG. 5C is a schematic view of the higher-order motional mode |nₚₕ [symbol] _{P-3} which has a lower energy than that of the tilt motional mode |nₚₕ [symbol] _{P-1}, and in which the ions move in a more complicated mode pattern.

It should be noted that the particular configuration described above is just one among several possible examples of a trap for confining ions according to the present disclosure and does not limit the possible configurations, specifications, or the like of traps according to the present disclosure. For example, the geometry of the electrodes is not limited to the hyperbolic electrodes described above. In other examples, a trap that generates an effective electric field causing the motion of the ions in the radial direction as harmonic oscillations may be a multi-layer trap in which several electrode layers are stacked, and an RF voltage is applied to two diagonally opposite electrodes, or a surface trap in which all electrodes are located in a single plane on a chip. Furthermore, a trap may be divided into multiple segments, adjacent pairs of which may be linked by shuttling one or more ions or coupled by photon interconnects. A trap may also be an array of individual trapping regions arranged closely to each other on a micro-fabricated ion trap chip. In some embodiments, the quadrupole potential has a spatially varying DC component in addition to the RF component described above.

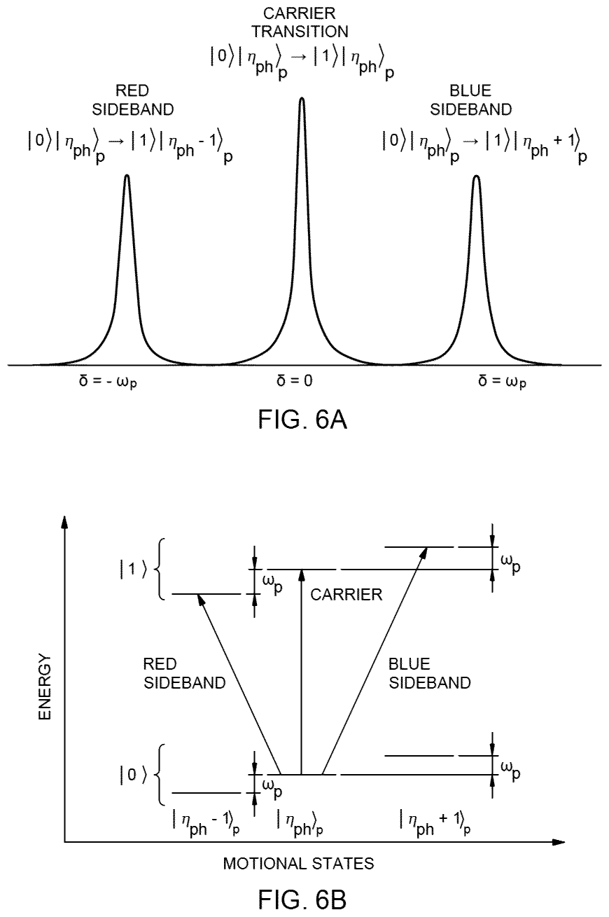

In an ion trap quantum computer, the motional modes may act as a data bus to mediate entanglement between two qubits and this entanglement is used to perform an XX gate operation. That is, each of the two qubits is entangled with the motional modes, and then the entanglement is transferred to an entanglement between the two qubits by using motional sideband excitations, as described below. FIGS. 6A and 6B schematically depict views of a motional sideband spectrum for an ion in the chain 106 in a motional mode |nₚₕ [symbol] ₚ having frequency ωₚ according to one embodiment. As illustrated in FIG. 6B, when the detuning frequency of the composite pulse is zero (i.e., the frequency difference between the first and second laser beams is tuned to the carrier frequency, δ=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=μ>0, referred to as a blue sideband, by cop), Rabi flopping between combined qubit-motional states |0 [symbol] |nₚₕ [symbol] ₚ and |1 [symbol] |nₚₕ+1 [symbol] ₚ occurs (i.e., a transition from the p-th motional mode with nₚₕ-phonon excitations denoted by |nₚₕ [symbol] ₚ to the p-th motional mode with nₚₕ+1-phonon excitations denoted by |nₚₕ+1 [symbol] ₚ occurs while the qubit state |0 [symbol] flips to |1 [symbol] ). When the detuning frequency of the composite pulse is negative (i.e., the frequency difference between the first and second laser beams is tuned lower than the carrier frequency by δ=−μ<0, referred to as a red sideband, by ωₚ), Rabi flopping between combined qubit-motional states |0 [symbol] |nₚₕ [symbol] ₚ and |1 [symbol] |nₚₕ−1 [symbol] ₚ occurs (i.e., a transition from |nₚₕ [symbol] ₚ to |nₚₕ−1 [symbol] with one less phonon excitations occurs while the qubit state |0 [symbol] flips to |1 [symbol] ). A π/2-pulse on the blue sideband applied to a qubit transforms the combined qubit-motional state |0 [symbol] |nₚₕ)ₚ into a superposition of |0 [symbol] |nₚₕ)ₚ and |1 [symbol] |nₚₕ+1)ₚ. A π/2-pulse on the red sideband applied to a qubit transforms the combined qubit-motional state |0 [symbol] |nₚₕ [symbol] ₚ into a superposition of |0 [symbol] |nₚₕ [symbol] ₚ and |1 [symbol] |nₚₕ−1)ₚ. When the two-photon Rabi frequency Ω(t) is smaller as compared to the detuning frequency δ=±μ, the blue sideband transition or the red sideband transition may be selectively driven. Thus, a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

By controlling and/or directing transformations of the combined qubit-motional states as described above, an XX-gate operation may be performed on two qubits (i-th and j-th qubits). In general, the XX-gate operation (with maximal entanglement) respectively transforms two-qubit states |0 [symbol] ᵢ|0 [symbol] ⱼ, |0 [symbol] ᵢ|1 [symbol] ⱼ, |1 [symbol] ᵢ|0 [symbol] ⱼ, and |1 [symbol] ᵢ|1 [symbol] ⱼ as follows:

$$\begin{matrix}{{{{{{\vert 0 〉}_{i} \vert 0 〉}_{j} \to \vert 0 〉}_{i} \vert 0 〉}_{j} - i \vert 1 〉}_{i} \vert 1 〉}_{j} \\ {{{{{{\vert 0 〉}_{i} \vert 1 〉}_{j} \to \vert 0 〉}_{i} \vert 1 〉}_{j} - i \vert 1 〉}_{i} \vert 0 〉}_{j} \\ {{{{{{\vert 1 〉}_{i} \vert 0 〉}_{j} \to \vert 1 〉}_{i} \vert 0 〉}_{j} - i \vert 0 〉}_{i} \vert 1 〉}_{j} \\ {{{{{{\vert 1 〉}_{i} \vert 1 〉}_{j} \to \vert 1 〉}_{i} \vert 1 〉}_{j} - i \vert 0 〉}_{i} \vert 0 〉}_{j}\end{matrix}$$

For example, when the two qubits (i-th and j-th qubits) are both initially in the hyperfine ground state |0 [symbol] (denoted as |0 [symbol] ᵢ|0 [symbol] ⱼ) and subsequently a π/2-pulse on the blue sideband is applied to the i-th qubit, the combined state of the i-th qubit and the motional mode |0 [symbol] ᵢ|nₚₕ [symbol] ₚ is transformed into a superposition of |0 [symbol] ᵢ|ₚₕ [symbol] ₚ and |1 [symbol] ᵢ|ₚₕ+1 [symbol] , and thus the combined state of the two qubits and the motional mode is transformed into a superposition of |0 [symbol] ᵢ|0 [symbol] ⱼ|nₚₕ [symbol] ₚ and |1 [symbol] ᵢ|0 [symbol] ⱼ|nₚₕ+1 [symbol] ₚ. When a π/2-pulse on the red sideband is applied to the j-th qubit, the combined state of the j-th qubit and the motional mode |0 [symbol] ⱼ|nₚₕ [symbol] ₚ is transformed to a superposition of |0 [symbol] ⱼ|nₚₕ [symbol] ₚ and |1 [symbol] ⱼ|nₚₕ−1 [symbol] ₚ and the combined state |0 [symbol] ᵢ|0 [symbol] ⱼ|nₚₕ [symbol] ₚ is transformed into a superposition of |0 [symbol] ᵢ|0 [symbol] ⱼ|nₚₕ [symbol] ₚ and |0 [symbol] ᵢ|1 [symbol] ⱼ|nₚₕ−1 [symbol] ₚ.

Thus, applications of a π/2-pulse on the blue sideband on the i-th qubit and a π/2-pulse on the red sideband on the j-th qubit may transform the combined state of the two qubits and the motional mode |0 [symbol] ᵢ|₀ [symbol] ⱼ|nₚₕ [symbol] ₚ into a superposition of |0 [symbol] ᵢ|0 [symbol] ⱼ|nₚₕ [symbol] ₚ and |1 [symbol] ᵢ|1 [symbol] ⱼ|nₚₕ [symbol] _{P}, the two qubits now being in an entangled state. For those of ordinary skill in the art, it should be clear that two-qubit states that are entangled with a motional mode having a different number of phonon excitations from the initial number of phonon excitations (i.e., |1 [symbol] ᵢ|0 [symbol] ⱼ|nₚₕ+1 [symbol] ₚ and |0 [symbol] ᵢ|0 [symbol] ⱼ|ₚₕ−1 [symbol] ) can be removed by a sufficiently complex pulse sequence, and thus the combined state of the two qubits and the motional mode after the XX-gate operation may be considered disentangled as the initial number of phonon excitations nₚₕ in the p-th motional mode stays unchanged at the end of the XX-gate operation. Thus, qubit states before and after the XX-gate operation will be described below generally without including the motional modes.

More generally, the combined state of i-th and j-th qubits, transformed by the application of control pulses described by pulse functions gᵢ(t) and gⱼ(t), respectively, for duration τ (referred to as the “gate time”), can be described in terms of a degree of entanglement (also referred to as a “gate angle”) χᵢⱼ as follows:

$$\begin{matrix}{{{{{{\vert 0 〉}_{i} \vert 0 〉}_{j} \to cos ( 2 {χ}_{ij} ) \vert 0 〉}_{i} \vert 0 〉}_{j} - i sin ( 2 {χ}_{ij} ) \vert 1 〉}_{i} \vert 1 〉}_{j} \\ {{{{{{\vert 0 〉}_{i} \vert 1 〉}_{j} \to cos ( 2 {χ}_{ij} ) \vert 0 〉}_{i} \vert 1 〉}_{j} - i sin ( 2 {χ}_{ij} ) \vert 1 〉}_{i} \vert 0 〉}_{j} \\ {{{{{{\vert 1 〉}_{i} \vert 0 〉}_{j} \to cos ( 2 {χ}_{ij} ) \vert 1 〉}_{i} \vert 0 〉}_{j} - i sin ( 2 {χ}_{ij} ) \vert 0 〉}_{i} \vert 1 〉}_{j} \\ {{{{{{\vert 1 〉}_{i} \vert 1 〉}_{j} \to cos ( 2 {χ}_{ij} ) \vert 1 〉}_{i} \vert 1 〉}_{j} - i sin ( 2 {χ}_{ij} ) \vert 0 〉}_{i} \vert 0 〉}_{j}\end{matrix}$$

where

$${χ}_{ij} = {\sum }_{p = 1}^{P} {η}_{p}^{i} {η}_{p}^{j} {\int }_{0}^{τ} d {t}_{2} {\int }_{0}^{{t}_{2}} d {t}_{1} {g}_{i} ( {t}_{1} ) {g}_{i} ( {t}_{2} ) sin [ {ω}_{p} ( {t}_{2} - {t}_{1} ) ] ,$$

and ηₚⁱ is the Lamb-Dicke parameter that quantifies the coupling strength between the i-th qubit and the p-th motional mode having the frequency ωₚ, and P is the number of the motional modes (equal to the number N of ions in the chain 106).

The entanglement interaction between two qubits described above can be used to perform an XX-gate operation. The XX-gate operation (XX gate) along with single-qubit gate operations (R gates) forms a set of gates {R, XX} that can be used to build a quantum computer that is configured to perform desired computational processes. Among several known sets of logic gates by which any quantum algorithm can be decomposed, a set of logic gates, commonly denoted as {R, XX}, is native to a quantum computing system of trapped ions described herein. Here, the R gate corresponds to manipulation of individual qubit states of trapped ions, and the XX gate (also referred to as an “entangling gate”) corresponds to manipulation of the entanglement of two trapped ions.

### III. Trapped-ion Architecture and Hamiltonian

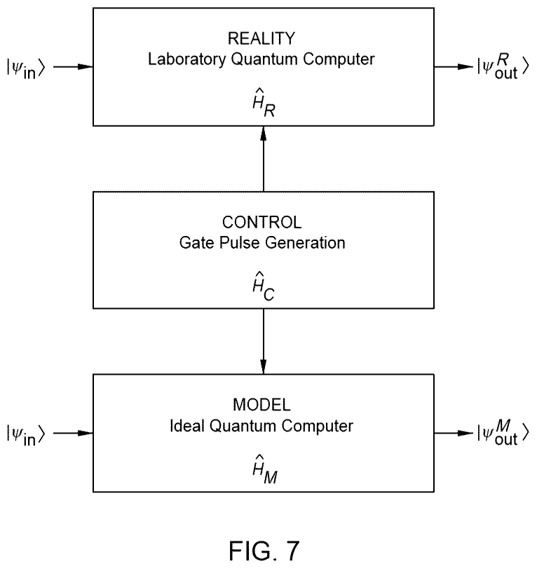

The trapped-ion architecture, i.e., chains of trapped ions, coherently controlled via Raman hyperfine transitions, is one of the most promising routes to scalable quantum computing. This quantum computer architecture is used both in laboratory experiments and in the emerging quantum computing industry. For both the current era of noisy intermediate-scale quantum computing and the anticipated era of fault-tolerant, error-corrected quantum computing, two-qubit gates of the highest possible fidelity are essential. While fault-tolerant quantum computing and quantum error-correction may, in principle, be achieved with two-qubit gates of modest fidelity, the overhead, i.e., the number of physical qubits required for one error-corrected logical qubit depends on the native fidelity of the physical gates and may be enormous for physical two-qubit gates of only modest fidelity. A reasonable amount of overhead in fault-tolerant quantum computing can be achieved only if the physical two-qubit gates themselves have a high native fidelity. Typically, for realistic, tolerable overhead, a physical two-qubit infidelity of ≤10⁻⁴ is recommended. Two-qubit gate infidelities close to this target have indeed already been achieved. However, the experimental demonstrations of high-fidelity two-qubit gates are restricted to two-qubit gates in very short ion chains, i.e., chains consisting of up to four ions. Moreover, to date, even in these cases two-qubit gate infidelities of ≤10⁻⁴ have not yet been achieved experimentally. Two adversaries stand in the way of achieving two-qubit gate infidelities ≤10⁻⁴: Random noise and deterministic, coherent control errors. Even in the shortest chains (two to four ions stored simultaneously), the target of ≤10⁻⁴ infidelity may not be achieved if the Hamiltonian used to design the control pulses for two-qubit gate implementation does not accurately enough reflect the reality of the quantum computer's hardware implementation. What this means is illustrated in FIG. 7. The actual quantum computer, i.e., the reality, is governed by a Hamiltonian Ĥ_{R}. Reality can never be captured exactly. It can only be modeled approximately. Consequently a model of the quantum computer is constructed, replacing the unknown Hamiltonian Ĥ_{R} with Ĥ_{M}, where it is hoped that Ĥ_{M}˜Ĥ_{R} to a high accuracy. Both the quantum computer (Ĥ_{R}) and its model (Ĥ_{M}) are controlled by control pulses that are constructed on the basis of a Hamiltonian Ĥ_{C}. Ideally, Ĥ_{C}=Ĥ_{R}. However, since Ĥ_{R} is unknown, the best possible control Hamiltonian is Ĥ_{C}=Ĥ_{M}. However, in most cases Ĥ_{M} is too complicated to use for efficiently constructing control pulses that frequently also have to be computed in real time. Therefore, Ĥ_{C} is chosen as a compromise, close enough to Ĥ_{M} to ensure acceptable control of the quantum computer, but simple enough to ensure efficient control-pulse construction.

One of the most basic tasks of a quantum computer is to construct two-qubit gates. In the embodiments described herein, two-qubit XX gates constructed according to the Mølmer-Sørensen scheme are considered. Ideally, given an input state, |ψᵢₙ [symbol] , the quantum computer, governed by Ĥ_{R}, is expected to turn |ψᵢₙ [symbol] into |ψₒᵤₜ [symbol] =XX|ψᵢₙ [symbol] , where XX is the ideal XX gate. However, since Ĥ_{R}≠Ĥ_{C}, this will not happen in practice. Therefore, |ψₒᵤₜ^{R} [symbol] , i.e., the output state produced by Ĥ_{R}, is different from XX|ψᵢₙ [symbol] . However, assuming that Ĥ_{M} is very close to Ĥ_{R}, it is possible, at least approximately, to assess the quality of the control pulses by computing the model output state |ψₒᵤₜ^{M} [symbol] and comparing it with the ideal output state XX|ψᵢₙ [symbol] , for instance, by computing the overlap | [symbol] ψₒᵤₜ^{M}|XX|ψᵢₙ [symbol] |². Only for H_{C}=Ĥ_{M} is it expected that this overlap equals 1. However, if Ĥ_{M} is close to Ĥ_{R}, but Ĥ_{C} is chosen as the manageable standard Hamiltonian Ĥ_{S}, it is expected that this overlap and other fidelity measures (see Section VI) differ from 1. In this case, because of the insufficient quality of the control pulses, the resulting two-qubit gates may not be accurate enough for the target infidelity (for instance, <10⁻⁴). To this end, constructing a realistic model Hamiltonian Ĥ_{M} for Raman-controlled trapped ions, it is shown that currently employed control-pulse construction techniques based on the standard Hamiltonian Ĥ_{S}, i.e., Ĥ_{C}=Ĥ_{S} are not accurate enough to achieve the ≤10⁻⁴ infidelity target for realistic fault-tolerant quantum computing. This is shown by constructing control pulses on the basis of Ĥ_{S}, which are then used to compute two-qubit XX gates in a 7-ion chain governed by Ĥ_{M}, assuming that Ĥ_{M} is sufficiently close to Ĥ_{R}. The XX gate simulations of the 7-ion chain are performed with a gate-simulator code that is accurate on the 10⁻⁷ level and takes both computational levels and phonon states explicitly into account. This way it is shown that even assuming ideal conditions, i.e., neglecting all incoherent noise sources, control-pulse construction needs to be improved to reach the ≤10⁻⁴ infidelity goal.

There are two principal methods of implementing a trapped-ion chain quantum computer using the stimulated Raman scheme: Phase sensitive and phase insensitive. Both schemes have advantages and disadvantages. The phase-sensitive scheme is focused since it is technically more straightforward to implement and is currently used by commercial quantum computing companies such as IonQ, Inc. Therefore, the focus is to isolate the leading coherent error sources in the phase-sensitive architecture and to construct methods that allow us to eliminate these error sources. It is shown that on the basis of a new linear scheme of pulse construction, and in the absence of all incoherent error sources, XX gate infidelities ≤10⁻⁴ can be reached.

The entangling gate can be constructed from the model Hamiltonian Ĥ_{M} (referred to as the full Mølmer-Sørensen Hamiltonian) that governs a chain of ions in a linear Paul trap (e.g., the chain 106 of trapped ions, illuminated simultaneously by two laser beams, one red detuned and one blue detuned). The effective two-level Hamiltonian:

$$\hat{H} = {\hat{H}}_{0} + {\sum }_{j = 1}^{N} ( \frac{ℏ {Ω}_{eff} ( t )}{2} ) {e}^{- i [ ( Δ \vec{k} ) \cdot {\vec{r}}_{j} - μ t - Δφ ]} {\hat{σ}}_{-}^{( j )} + h . c . , \qquad ( 1 )$$

can be obtained via adiabatic elimination according to the Raman Λ scheme. Here, N is the number of ions in the chain,

$${\hat{H}}_{0} = {\sum }_{p = 1}^{N} {ω}_{p} {\hat{a}}_{p}^{†} {\hat{a}}_{p} \qquad ( 2 )$$

is the phonon Hamiltonian with the phonon frequencies ωₚ and associated phonon creation and destruction operators \hat{α}ₚ^{†} and âₚ, respectively, the j sum is over the ions in the chain, Ω_{eff}(t) is the time-dependent effective Rabi frequency, Δ\vec{k} is the wavenumber difference between the two Raman lasers, \vec{r}ⱼ is the position operator of ion number j in the chain, and Δφ is the phase difference between the two Raman lasers.

To construct a Mølmer-Sørensen (MS) gate, the ions are illuminated simultaneously with blue (+μ) and red (−μ) shifted light. In the interaction representation with respect to Ĥ₀, the MS Hamiltonian is:

$${\hat{H}}_{M S} ( t ) = {\sum }_{j} {Ω}_{j} cos ( μ t - {ϕ}_{j}^{m} ) \{ cos [ {\sum }_{p} {η}_{p}^{j} ( {\hat{a}}_{p}^{†} \cdot {e}^{i {ω}_{p} t} + {\hat{a}}_{p} {e}^{- i {ω}_{p} t} ) ] {\hat{σ}}_{y}^{( j )} + sin [ {\sum }_{p} {η}_{p}^{j} ( {\hat{a}}_{p}^{†} {e}^{i {ω}_{p} t} + {\hat{a}}_{p} {e}^{- i {ω}_{p} t} ) ] {\hat{σ}}_{x}^{( j )} \} , \qquad ( 3 )$$

where μ is the detuning frequency, ηₚ^{j} are the Lamb-Dicke parameters, and \hat{σ}ₓ, \hat{σ}_{y}, \hat{σ}_{z} are the Pauli operators. The Hamiltonian (3) may be generalized according to:

$${Ω}_{j} cos ( μ t - {ϕ}_{j}^{m} ) \to {Ω}_{j} ( t ) cos [ {\int }_{0}^{t} μ ( {t}^{′} ) {dt}^{′} + {ϕ}_{j}^{( 0 )} ] \to {g}_{j} ( t ) , \qquad ( 4 )$$

where gⱼ(t) may be any time-dependent pulse function, i.e., it includes amplitude-modulated (AM) pulses, frequency-modulated (FM) pulses, phase-modulated (PM) pulses, and simultaneously amplitude- and frequency-modulated (AMFM) pulses. Thus, written in terms of the most general pulse function gⱼ(t), the MS Hamiltonian (3) becomes:

$${\hat{H}}_{M S} = {\sum }_{j} {g}_{j} ( t ) \{ cos [ \hat{{V}_{j}} ( t ) ] {\hat{σ}}_{y}^{0 )} + sin [ \hat{{V}_{j}} ( t ) ] {\hat{σ}}_{x}^{( j )} \} , \qquad ( 5 )$$

where, for later convenience, the Lamb-Dicke operators are defined as:

$${\hat{V}}_{j} ( τ ) = {\sum }_{p} {η}_{p}^{j} ( {\hat{a}}_{p}^{†} {e}^{i {ω}_{p} t} + {\hat{a}}_{p} {e}^{- i {ω}_{p} t} ) , \qquad ( 6 )$$

which satisfy

$$[ {\hat{V}}_{j} ( {t}_{1} ) , {\hat{V}}_{l} ( {t}_{2} ) ] = - 2 i {\sum }_{p} {η}_{p}^{j} {η}_{p}^{l} sin [ {ω}_{p} ( {t}_{1} - {t}_{2} ) ] . \qquad ( 7 )$$

Expansion of the MS Hamiltonian Ĥ_{MS} in powers of \hat{V} leads to a family of model Hamiltonians:

$${\hat{H}}_{M}^{( {N}_{c} , {N}_{s} )} = {\sum }_{j} {g}_{j} ( t ) \{ {\sum }_{\begin{matrix}n = 0 \\ neven\end{matrix}}^{{N}_{c}} {( - 1 )}^{n / 2} \frac{{\hat{σ}}_{y}^{( j )}}{n !} {\hat{V}}_{j}^{n} ( t ) + {\sum }_{\begin{matrix}m = 1 \\ modd\end{matrix}}^{{N}_{s}} {( - 1 )}^{( m - 1 ) / 2} \frac{{\hat{σ}}_{x}^{( j )}}{m !} {\hat{V}}_{j}^{m} ( t ) \} , \qquad ( 8 )$$

$$where$$

$${\hat{H}}_{M}^{( ∞ , ∞ )} = {\hat{H}}_{M S} . \qquad ( 9 )$$

For later convenience, the standard Hamiltonian is also defined as:

$${\hat{H}}_{S} = {\hat{H}}_{M}^{( - 2 , 1 )} = {\sum }_{j} ℏ {g}_{j} ( t ) \hat{{V}_{j}} ( t ) {\hat{σ}}_{x}^{( j )} , \qquad ( 10 )$$

which is frequently used as the basis for control-pulse construction. Here, the superscript N_{c}=−2 codes for the complete suppression (omission) of the cosine term in (8). The test pulses used in the example are also all constructed on the basis of the standard Hamiltonian Ĥ_{S} (as discussed in detail below in Section IV). The expanded model Hamiltonians (8) are use in Section VII to assess the accuracy of expansions of the MS Hamiltonian Ĥ_{MS} in powers of the Lamb-Dicke operators \hat{V}ⱼ(t).

### IV. Construction of Control Pulses for Entangling Gate Operations

Quantum computation can be performed in a quantum computing system, such as the ion trap quantum computing system 100, using a set of quantum gate operations including single-qubit gate operations (R gates) and two-qubit gate operations, such as XX-gate operations (XX gates). Although the methods for applying such basic building blocks of quantum computation have been established, there are errors, which result from experimental parameter drift or fluctuations, such as the vibrational mode frequencies of an ion chain, in the hardware of the quantum computing system. These errors are mainly due to the lack of knowledge about the changes in the computing environment and the properties of quantum computing hardware within the quantum computing system. Thus, stabilizing gate operations, i.e., the task of computing and implementing control pulses in the quantum computing system to be robust against the errors is needed to provide scalable and reliable quantum computation results.

While the pulse functions g(t) may be any pulse functions constructed by any of the known pulse construction schemes (e.g., AM, PM, FM, AMFM, etc.), to be specific, and for the purpose of illustrating the methods, but not restricting the generality of the methods in any way, in the embodiments described herein, the pulse functions g(t) of a control pulse are taken to be sine-AMFM pulses:

$$g ( t ) = {\sum }_{{n}_{min}}^{{n}_{max}} {B}_{n} sin ( {ω}_{n} t ) , \qquad ( 11 )$$

where the basis spans the states n∈{nₘᵢₙ, nₘₐₓ}, the Fourier coefficients Bₙ are real amplitudes,

$${ω}_{n} = \frac{2 π n}{τ} \qquad ( 12 )$$

are the basis frequencies, and r is the gate time. The pulse functions (11) fulfill the “carrier condition”

$${\int }_{0}^{τ} g ( t ) dt = 0 , \qquad ( 13 )$$

which, as shown in Section IX, ensures that significant, first-order contributions to the gate infidelity due to the “carrier term”, i.e., the n=0 term in the expansion (8) of the MS Hamiltonian, are eliminated, and higher-order contributions to the gate infidelity are much reduced.

The phase-space closure condition requires:

$${α}_{p}^{j} = - {η}_{p}^{j} {\int }_{0}^{τ} {g}_{j} ( t ) {e}^{i {ω}_{p} t} dt = 0 ( p , j = 1 , … , N ) , \qquad ( 14 )$$

such that the trapped ions that are displaced from their initial positions as the motional modes are excited by the delivery of the control pulse return to their initial motional states. This condition must be imposed for all motional modes (p=1,2, . . . , N) and all ions (j=1, . . . ,N) in the chain of trapped ions. The sine-AMFM pulses (11) are known to fulfill (14) exactly. The number of ions in the chain is chosen as N=7, as an example, because it is large enough to be realistic, yet small enough to enable direct numerical simulations of the quantum dynamics of the chain, explicitly including a large phonon space. In addition, in the embodiments described herein, gⱼ(t)=g(t) (=1, . . . , N) is chosen for illustrative purposes but is not intended to be a restriction of generality. That is, here, whenever a two-qubit gate is constructed between two ions, it is assumed that each of the two ions is irradiated with laser light controlled by the same pulse function g(t). This is a common choice, used in laboratories and in commercial quantum computers.

Among the pulse functions g(t) that fulfill the phase-space closure condition and the carrier condition, the pulse function g(t) that satisfies the gate angle condition, which requires the pulse g(t) to produce the desired gate angle χ according to:

$$χ = 2 {\sum }_{p = 1}^{N} {η}_{p}^{{j}_{1}} {η}_{p}^{{j}_{2}} {\int }_{0}^{τ} dt {\int }_{0}^{t} {dt}^{′} g ( t ) g ( {t}^{′} ) sin [ {ω}_{p} ( t - {t}^{′} ) ] , \qquad ( 15 )$$

is selected. A maximally entangling gate is obtained for χ=π/4. The mode frequencies ωₚ, p=1, . . . ,7, and the Lamb-Dicke parameters ηₚ^{j}, p,j=1, . . . ,7, are listed in Tables I and II, respectively.

TABLE I
Motional-mode frequencies ωₚ/(2π) (in MHz), p = 1, . . . ,
7, used to construct the 7-ion AMFM test pulses:

| mode number p | ωₚ/(2π) (MHz) |
|---|---|
| 1 | 2.953 |
| 2 | 2.966 |
| 3 | 2.984 |
| 4 | 3.006 |
| 5 | 3.029 |
| 6 | 3.049 |
| 7 | 3.060 |

TABLE II
Lamb-Dicke parameters ηₚ^{j}, p, j = 1, . . . ,
7, used to construct the 7-ion AMFM test pulses:

| p | j = 1 | j = 2 | j = 3 | j = 4 | j = 5 | j = 6 | j = 7 |
|---|---|---|---|---|---|---|---|
| 1 | 0.01033 | −0.03355 | 0.05478 | −0.06313 | 0.05478 | −0.03355 | 0.01033 |
| 2 | 0.02226 | −0.05627 | 0.05036 | 0.00000 | −0.05036 | 0.05627 | −0.02226 |
| 3 | −0.03494 | 0.05644 | 0.00760 | −0.05823 | 0.00760 | 0.05644 | −0.03494 |
| 4 | 0.04644 | −0.03074 | −0.05488 | 0.00000 | 0.05488 | 0.03074 | −0.04644 |
| 5 | 0.05503 | 0.00994 | −0.03678 | −0.05637 | −0.03678 | 0.00994 | 0.05503 |
| 6 | −0.05848 | −0.04491 | −0.02433 | 0.00000 | 0.02433 | 0.04491 | 0.05848 |
| 7 | 0.04143 | 0.04143 | 0.04143 | 0.04143 | 0.04143 | 0.04143 | 0.04143 |

For computing analytical infidelities the following identities that follow directly from (14) with the expansion (11) and hold for all p=1, . . . , N are used:

$${\int }_{0}^{τ} g ( t ) {e}^{\pm i {ω}_{p} t} dt = 0 , \qquad ( 16 )$$

$${\int }_{0}^{τ} g ( t ) sin ( {ω}_{p} t ) dt = 0 , \qquad ( 17 )$$

$${\int }_{0}^{τ} g ( t ) cos ( {ω}_{p} t ) dt = 0 , \qquad ( 18 )$$

$${\sum }_{{n}_{min}}^{{n}_{max}} {B}_{n} ( \frac{{ω}_{n}}{{ω}_{n}^{2} - {ω}_{p}^{2}} ) = 0. \qquad ( 19 )$$

For later use in the following sections, the following functions are defined:

$$\tilde{χ} = {\sum }_{jp} {( {η}_{p}^{j} )}^{2} {\int }_{0}^{τ} dt {\int }_{0}^{t} {dt}^{′} g ( t ) g ( {t}^{′} ) sin [ {ω}_{p} ( t - {t}^{′} ) ] , \qquad ( 20 )$$

$$G ( t ) = {\int }_{0}^{t} g ( {t}^{′} ) {dt}^{′} = {\sum }_{n} ( \frac{{B}_{n}}{{ω}_{n}} ) [ 1 - cos ( {ω}_{n} t ) ] = 2 {\sum }_{n} ( \frac{{B}_{n}}{{ω}_{n}} ) {sin}^{2} ( {ω}_{n} t / 2 ) , \qquad ( 21 )$$

$$Q ( w ) = {\int }_{0}^{τ} g ( t ) {e}^{iwt} dt = [ {e}^{i w τ} - 1 ] {\sum }_{n} {B}_{n} ( \frac{{ω}_{n}}{{w}^{2} - {ω}_{n}^{2}} ) , \qquad ( 22 )$$

$$f ( w ) = {\int }_{0}^{τ} g ( t ) G ( t ) {e}^{iwt} dt = ( \frac{1}{2} ) [ {e}^{l w τ} - 1 ] {\sum }_{n m} ( \frac{{B}_{n} {B}_{m}}{{ω}_{n}} ) \{ \frac{{ω}_{m} - {ω}_{n}}{{( {ω}_{m} - {ω}_{n} )}^{2} - {w}^{2}} + \frac{{ω}_{m} + {ω}_{n}}{{( {ω}_{m} + {ω}_{n} )}^{2} - {w}^{2}} \} , \qquad ( 23 )$$

$${S}_{p} ( w ) = {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] {e}^{{iwt}_{1}} = {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] {e}^{{iwt}_{2}} = {\sum }_{nm} \frac{{B}_{n} {B}_{m}}{2 ( {w}^{2} - {ω}_{m}^{2} )} \{ ( \frac{2 {ω}_{n} {ω}_{m}}{{ω}_{n}^{2} - 4 {w}^{2}} ) {e}^{iw τ} sin ( w τ ) + {iw}^{2} ( {e}^{iw τ} - 1 ) [ \frac{1}{{( {ω}_{n} - {ω}_{m} )}^{2} - {w}^{2}} - \frac{1}{{( {ω}_{n} - {ω}_{m} )}^{2} - {w}^{2}} ] \} , \qquad ( 24 )$$

$${J}_{p} = {\int }_{0}^{τ} g ( t ) {G}^{2} ( t ) {e}^{i {ω}_{p} t} dt , \qquad ( 25 )$$

$$Z ( {w}_{1} , {w}_{2} ) = {\int }_{0}^{τ} {dt}_{1} {\int }_{0}^{{t}_{1}} {dt}_{2} g ( {t}_{1} ) g ( {t}_{2} ) {e}^{{iw}_{1} {t}_{1}} {e}^{{iw}_{2} {t}_{2}} = {\sum }_{nm} {B}_{n} {B}_{m} ( \frac{1}{{ω}_{m}^{2} - {w}_{2}^{2}} ) \{ ( \frac{{ω}_{n} {ω}_{m}}{{w}_{1}^{2} - {ω}_{n}^{2}} ) [ {e}^{{iw}_{1} τ} - 1 ] - ( \frac{{ω}_{n} {ω}_{m} ( {ω}_{m}^{2} - {ω}_{n}^{2} + {w}_{1}^{2} + 4 {w}_{1} {w}_{2} + 3 {w}_{2}^{2} )}{[ {( {ω}_{n} + {ω}_{m} )}^{2} - {( {w}_{1} + {w}_{2} )}^{2} ] [ {( {ω}_{n} - {ω}_{m} )}^{2} - {( {w}_{1} + {w}_{2} )}^{2} ]} ) [ {e}^{i ( {w}_{1} + {w}_{2} ) τ} - 1 ] \} , \qquad ( 26 )$$

$$and$$

$$Φ [ η , g ] = {\sum }_{p = 1}^{N} {η}_{p}^{1} {η}_{p}^{2} {\int }_{0}^{τ} {dt}_{1} {\int }_{0}^{{t}_{1}} {dt}_{2} g ( {t}_{1} ) g ( {t}_{2} ) G ( {t}_{2} ) sin [ {ω}_{p} ( {t}_{1} - {t}_{2} ) ] = \frac{χ τ}{4 π} {\sum }_{n = {n}_{min}}^{{n}_{max}} \frac{{B}_{n}}{n} , \qquad ( 27 )$$

where (15) is used and

$${\sum }_{n} ( \frac{{B}_{n}}{n} ) = ( \frac{2 π}{{τ}^{2}} ) {\int }_{0}^{τ} dt {\int }_{0}^{t} {dt}^{′} g ( {t}^{′} ) {dt}^{′} . \qquad ( 28 )$$

### V. Gate Simulator

Given a Hamiltonian and enough computer power, the time evolution of the computational states including phonon excitations can always be solved to any desired accuracy. For a 7-ion chain, the complete state |ψ(t) [symbol] can be expanded in the combined Hilbert space of computational states |a, b [symbol] , a, b∈{0,1}, and phonon states |m₁m₂ . . . m₇ [symbol] , mⱼ=0,1, . . . , mⱼ^{max}, j=1, . . . ,7, according to:

$$\vert ψ ( t ) 〉 = {\sum }_{{a , b}_{{m}_{1} {m}_{2} … {m}_{7}}} {A}_{{m}_{1} {m}_{2} … {m}_{7}}^{( a , b )} ( t ) \vert a , b 〉 \vert {m}_{1} {m}_{2} … {m}_{7} 〉 , \qquad ( 29 )$$

where mⱼ^{max}≥0 is the maximal phonon occupation number included in the basis. The set {m₁^{max}, . . . , m₇^{max}} is referred to as the phonon scheme. With (29), the time-dependent Schrödinger equation results in the amplitude equations:

$$i ℏ {\dot{A}}_{{n}_{1} {n}_{2} … {n}_{7}}^{( a , b )} ( t ) = {\sum }_{{{a}^{′} , {b}^{′}}_{{m}_{1} {m}_{2} … {m}_{7}}} 〈 a , b \vert 〈 {n}_{1} … {n}_{7} \vert \hat{H} ( t ) \vert {m}_{1} … {m}_{7} 〉 \vert {a}^{′} , {b}^{′} 〉 {A}_{{m}_{1} … {m}_{7}}^{( {a}^{′} , {b}^{′} )} ( t ) , \qquad ( 30 )$$

where Ĥ(t) may be any of the model Hamiltonians defined in Section III. The set of equations (30) are ordinary first-order differential equations that may be solved with any standard numerical differential equations solver. For simplicity and straightforward numerical error control, an elementary fourth-order Runge-Kutta solver with constant step size is chosen. With this simple integrator, the inventors have been able to obtain a relative accuracy of the numerical solution of better than 10⁻⁷. It should be noted that the gate simulator is not limited to 7 ions. It scales trivially to any number of ions.

Convergence in the phonon scheme is assessed by using the gate simulator to compute |ψ(τ) [symbol] for the Hamiltonian Ĥ(t)=Ĥ_{S}(t)=Ĥ^{-2,1)}(t). In this case, full phase- [symbol] space closure is required, because the control pulses are constructed on the basis of the same Hamiltonian that governs the time evolution. Only if enough phonon states are included in the basis used by the gate-simulator, will the phase space be closed and thus the phonon-space truncation according to the phonon scheme will guarantee an accurate result.

### VI. Fidelity Measures

The ideal XX gate propagator is:

$${\hat{U}}_{ideal} = {e}^{i χ {σ}_{x}^{( 1 )} {σ}_{x}^{( 2 )}} , \qquad ( 31 )$$

where χ is the gate angle. For starting state |ψ₀ [symbol] this produces the ideal final state:

$$\vert {ψ}_{ideal} 〉 = {\hat{U}}_{ideal} \vert {ψ}_{0} 〉 . \qquad ( 32 )$$

However, a given gate pulse g(t), in general, produces a gate propagator of the form:

$${\hat{U}}_{actual} = {e}^{i [ {χσ}_{x}^{( 1 )} {σ}_{x}^{( 2 )} + λ Ê ]} , \qquad ( 33 )$$

where Ê is a Hermitian error operator and λ is its error strength. In this case, and for given initial state |ψ₀ [symbol] , the state fidelity F_{S} is defined as:

$${F}_{S} = \vert 〈 {ψ}_{ideal} \vert {ψ}_{actual} 〉 {\vert}^{2} = \vert 〈 {ψ}_{0} \vert {\hat{U}}_{ideal}^{†} {\hat{U}}_{actual} \vert {ψ}_{0} 〉 {\vert}^{2} . \qquad ( 34 )$$

There are two types of error operators, i.e., those that commute with the product of the Pauli operators σₓ⁽¹⁾σₓ⁽²⁾ and those that do not. If only a single, commuting error operator Ê is present, the state fidelity F_{S}, up to second order in the error strength λ, is:

$${F}_{S} = \vert 〈 {ψ}_{0} \vert {e}^{- i {χσ}_{x}^{( 1 )} {σ}_{x}^{( 2 )} + i λ Ê} {e}^{i {χσ}_{x}^{( 1 )} {σ}_{x}^{( 2 )} + i λ Ê} \vert {ψ}_{0} 〉 {\vert}^{2} = \vert 〈 {ψ}_{0} \vert {e}^{i λ Ê} \vert {ψ}_{0} 〉 {\vert}^{2} = 1 - {λ}^{2} {σ}_{Ê}^{2} , \qquad ( 35 )$$

$$where$$

$${σ}_{Ê}^{2} = 〈 {ψ}_{0} \vert {Ê}^{2} \vert {ψ}_{0} 〉 - 〈 {ψ}_{0} \vert Ê \vert {ψ}_{0} {〉}^{2} . \qquad ( 36 )$$

This means that the state infidelity F̅_{S}:

$${\overline{F}}_{S} = 1 - {F}_{S} , \qquad ( 37 )$$

up to second order in the error strength λ, is:

$${\overline{F}}_{S} = {λ}^{2} {σ}_{\hat{E}}^{2} . \qquad ( 38 )$$

The state infidelity F̅_{S} is proportional to the square of the error strength λ.

In case the error operator Ê does not commute with the product of the Pauli operators σₓ¹αₓ⁽²⁾, the Baker-Hausdorff-Campbell formula can be used to obtain the state fidelity F_{S}, up to second order in the error strength λ,

$${{{F}_{s} = \vert {ψ}_{0} \vert {\hat{U}}_{ideal}^{†} {\hat{U}}_{actual} \vert {ψ}_{0} 〉 {\vert}^{2} = \vert 〈 {ψ}_{0} \vert {e}^{- i χ {σ}_{x}^{( 1 )} {σ}_{x}^{( 2 )}} {e}^{- i χ {σ}_{x}^{( 1 )} {σ}_{x}^{( 2 )} + i λ \hat{E}} \vert {ψ}_{0} 〉 {\vert}^{2} = \vert 〈 {ψ}_{0} \vert {e}^{i λ \hat{C} + i {λ}^{2} \hat{D} + ⋯} \vert {ψ}_{0} 〉 \vert}^{2} = \vert 〈 {ψ}_{0} \vert 1 + i λ ( \hat{C} + λ \hat{D} ) - \frac{1}{2} {{λ}^{2} ( \hat{C} + λ \hat{D} )}^{2} + ⋯ \vert {ψ}_{0} 〉 \vert}^{2} = 1 - {λ}^{2} {σ}_{\hat{C}}^{2} , \qquad ( 39 )$$

where Ĉ and \hat{D} are Hermitian operators that can be expressed as linear combinations of nested multi-commutators of the product of the Pauli operators σₓ⁽¹⁾σₓ⁽²⁾ and the error operator Ê. This implies that in this case, too, the state infidelity F̅_{S} is proportional to the square of the error strength λ.

Most of the error operators Ê that appear in the present context do not commute with the product of the Pauli operators σₓ⁽¹⁾σₓ². However, if the error operator Ê can be written in the form Ê=Â\hat{Ω}, where Â is a Hermitian error operator in the computational space and \hat{Ω} is a Hermitian error operator in the phonon space, and if the error operator Â in the computational space fulfills the anti-commutation relation:

$$\{ {σ}_{x}^{( 1 )} {σ}_{x}^{( 2 )} , \hat{A} \} = {σ}_{x}^{( 1 )} {σ}_{x}^{( 2 )} , \hat{A} + A {σ}_{x}^{( 1 )} {σ}_{x}^{( 2 )} = 0 , \qquad ( 40 )$$

the state infidelity F̅_{S} can be computed explicitly, which also provides an explicit expression for the operator Ĉ in (39). Examples of error operators Â that fulfill (40) are:

$$A ∈ \{ {σ}_{y}^{( 1 )} , {σ}_{y}^{( 2 )} , {σ}_{z}^{( 1 )} , {σ}_{z}^{( 2 )} {σ}_{x}^{( 1 )} {σ}_{y}^{( 2 )} , {σ}_{x}^{( 1 )} {σ}_{z}^{( 2 )} {σ}_{x}^{( 2 )} {σ}_{y}^{( 1 )} , {σ}_{x}^{( 2 )} {σ}_{z}^{( 1 )} \} . \qquad ( 41 )$$

Since they act in different spaces, the following conditions are satisfied:

$$\begin{matrix}[ {σ}_{x}^{( 1 )} {σ}_{x}^{( 2 )} , \hat{Ω} ] = 0 , & [ \hat{A} , \hat{Ω} ]\end{matrix} = 0. \qquad ( 42 )$$

If (40) is fulfilled, Û_{actual} becomes:

$${\hat{U}}_{actual} = {e}^{i χ {σ}_{x}^{( 1 )} {σ}_{x}^{( 2 )} + i λ \hat{A} \hat{Ω}} = cos ( \hat{φ} ) + i ( \frac{sin ( \hat{φ} )}{\hat{φ}} ) [ {χσ}_{x}^{( 1 )} {σ}_{x}^{( 2 )} + i λ \hat{A} \hat{Ω} ] , \qquad ( 43 )$$

$$where$$

$$\hat{φ} = \sqrt{{χ}^{2} + {λ}^{2} {\hat{A}}^{2} {\hat{Ω}}^{2}} . \qquad ( 44 )$$

Then, up to second order in the error strength λ, the state fidelity F_{S} becomes:

$${F}_{S} = {\vert 1 + i ( \frac{λ}{χ} ) cos ( χ ) sin ( χ ) 〈 {ψ}_{0} \vert \hat{A} \hat{Ω} \vert {ψ}_{0} 〉 + ( \frac{λ}{χ} ) {sin}^{2} ( χ ) 〈 {ψ}_{0} \vert {σ}_{x}^{( 1 )} {σ}_{x}^{( 2 )} \hat{A} \hat{Ω} \vert {ψ}_{0} 〉 - ( \frac{{λ}^{2}}{2 {χ}^{2}} ) {sin}^{2} ( χ ) 〈 {ψ}_{0} \vert {\hat{A}}^{2} {\hat{Ω}}^{2} \vert {ψ}_{0} 〉 \vert}^{2} . \qquad ( 45 )$$

Now, (40) and (42) lead to:

$$〈 {ψ}_{0} \vert {σ}_{x}^{( 1 )} {σ}_{x}^{( 2 )} \hat{A} \hat{Ω} \vert {ψ}_{0} 〉 = - 〈 {ψ}_{0} \vert \hat{A} {σ}_{x}^{( 1 )} {σ}_{x}^{( 2 )} \hat{Ω} \vert {ψ}_{0} 〉 = - {〈 {ψ}_{0} \vert \hat{Ω} {σ}_{x}^{( 1 )} {σ}_{x}^{( 2 )} \hat{A} \vert {ψ}_{0} 〉}^{*} = - {〈 {ψ}_{0} \vert {σ}_{x}^{( 1 )} {σ}_{x}^{( 2 )} \hat{A} \hat{Ω} \vert {ψ}_{0} 〉}^{*} . \qquad ( 46 )$$

This means that [symbol] ψ₀|σₓ⁽¹⁾σₓ⁽²⁾Â\hat{Ω}|ψ₀ [symbol] is purely imaginary, and thus:

$$〈 {ψ}_{0} \vert {σ}_{x}^{( 1 )} {σ}_{x}^{( 2 )} \hat{A} \hat{Ω} \vert {ψ}_{0} 〉 = i \{ 〈 {ψ}_{0} \vert {σ}_{x}^{( 1 )} {σ}_{x}^{( 2 )} \hat{A} \hat{Ω} \vert {ψ}_{0} 〉 \} . \qquad ( 47 )$$

With this result, the state fidelity F_{S} can be written, up to second order in the error strength λ, as:

$${F}_{S} = 1 - ( \frac{{λ}^{2}}{{χ}^{2}} ) {sin}^{2} ( χ ) 〈 {ψ}_{0} \vert {\hat{A}}^{2} {\hat{Ω}}^{2} \vert {ψ}_{0} 〉 + ( \frac{{λ}^{2}}{{χ}^{2}} ) {{sin}^{2} ( χ ) [ cos ( χ ) 〈 {ψ}_{0} \vert \hat{A} Ω \vert {ψ}_{0} 〉 - i sin ( χ ) 〈 {ψ}_{0} \vert {σ}_{x}^{( 1 )} {σ}_{x}^{( 2 )} \hat{A} Ω \vert {ψ}_{0} 〉 ]}^{2} = 1 - {λ}^{2} {σ}_{\hat{C}}^{2} , \qquad ( 48 )$$

$$C = ( \frac{sin ( χ )}{χ} ) [ cos ( χ ) A Ω - i sin ( χ ) {σ}_{x}^{( 1 )} {σ}_{x}^{( 2 )} \hat{A} \hat{Ω} ] = ( \frac{sin ( χ )}{χ} ) {e}^{- i χ {σ}_{x}^{( 1 )} {σ}_{x}^{( 2 )}} \hat{A} \hat{Ω} . \qquad ( 49 )$$

It should be noted that, because of (42), and since the error operator Â in the computational space is assumed to fulfill (40), iσₓ⁽¹⁾σₓ⁽²⁾Â\hat{Ω} is a Hermitian operator. So, Ĉ is Hermitian, as it should be, and Ĉ²=Ĉ^{†}Ĉ. With this result, the state fidelity \hat{F}_{S} can be explicitly written as:

$${{F}_{S} = {( \frac{λsin ( χ )}{χ} )}^{2} \{ 〈 {ψ}_{0} \vert {\hat{A}}^{2} {\hat{Ω}}^{2} \vert {ψ}_{0} 〉 - 〈 {ψ}_{0} \vert {e}^{- i χ {σ}_{x}^{( 1 )} {σ}_{x}^{( 2 )}} \hat{A} \hat{Ω} \vert {ψ}_{0} 〉}^{2} \} . \qquad ( 50 )$$

The explicit form (48) of the state fidelity F_{S} confirms the general result (39) in cases where the condition (40) is met. Many of the most important error operators occurring satisfy (40) and thus (50) is applicable.

In the case of a two-qubit gate, the error operator Ê takes the form Ê=Σ_{j=1,2} Â^{(j)}\hat{Ω}^{(j)}. In this case (48), (49), and (50) may immediately be generalized using the substitution:

$$\hat{A} \hat{Ω} \to {\sum }_{j = 1 , 2} {\hat{A}}^{( j )} {\hat{Ω}}^{( j )} . \qquad ( 51 )$$

The output of the gate simulator code is the complete state |ψₒᵤₜ^{M}(τ) [symbol] , which includes computational states and phonon states. This way, the complete state information is available, which can be used to compute the state fidelity defined in (34) with |ψ_{actual} [symbol] =|ψₒᵤₜ^{M}(τ) [symbol] . In Section VII the state fidelity F_{S} is used to assess the quality of the various model Hamiltonians Ĥ_{M}^{N}^{_{c}}^{,N}^{ₛ}⁾.

The state fidelity F_{S}, as defined in (34), depends on the initial state |ψ₀ [symbol] . A more global measure of the fidelity of the quantum process that implements the two-qubit XX gate is the process fidelity

$${F}_{P} = \frac{1}{16} Tr [ {E}_{exact}^{†} {E}_{actual} ] , \qquad ( 52 )$$

where E_{exact} is the exact XX gate process and E_{actual} is the actual two-qubit XX-gate process as computed with the gate simulator as described in Section V.

A related fidelity measure, also used in Section VII, is the average gate fidelity F_{G}, which is defined as:

$${F}_{G} = \frac{1}{80} {\sum }_{j = 1}^{16} T r [ {\hat{U}}_{e x a c t} {\hat{U}}_{j}^{†} {\hat{U}}_{e x a c t}^{†} E ( {\hat{U}}_{j} ) ] , \qquad ( 53 )$$

where Ûⱼ, j=1, . . . ,16, is an operator basis in the computational space.

In addition to the state infidelity F̅_{S}=1−F_{S}, defined in (37), the average gate infidelity F̅_{G} and the process gate infidelity F̅_{P} are defined as:

$$\begin{matrix}{\overline{F}}_{G} = 1 - {F}_{G} , \\ {\overline{F}}_{P} = 1 - {F}_{P} .\end{matrix} \qquad ( 54 )$$

For characterizing the quality of the various Hamiltonians, it is useful to define the gate angle error:

$$Δχ = χ - \frac{π}{4} , \qquad ( 55 )$$

where χ is the actual gate angle computed by running the XX gate simulator (see Sections V and VII). A positive gate angle error Δχ corresponds to an over-rotated gate angle χ, while a negative Δχ corresponds to an under-rotated gate angle χ. The error operator associated with the gate angle error Δχ is Ê_{χ}=Δχ\hat{σ}⁽¹⁾\hat{σ}⁽²⁾. Then, according to (35), for |ψ₀ [symbol] =|00 [symbol] |ph [symbol] , for instance, where |00 [symbol] is the computational state and |ph [symbol] is any normalized phonon state, the state infidelity F̅_{S}^{(χ)} caused by Ê_{χ} is

$${{\overline{F}}_{S}}^{( χ )} = {( Δ χ )}^{2} . \qquad ( 56 )$$

### VII. Numerical Results

As described in Section IV, the inventors have computed AMFM pulse functions g(t) for gate times ranging from τ=100 μs to τ=600 μs in steps of 100 μs, and used these pulse functions in the XX gate simulator (see Section V). As described in Section V, using the full Hamiltonian Ĥ_{MS} defined in (5), the full state function |ψ(τ) [symbol] that includes both the computational space and the phonon space were computed. From |ψ(τ) [symbol] , as described in Section VI, the state infidelity F̅_{S}, the gate infidelity F̅_{G}, the process infidelity F̅_{P}, and the gate angle error Δχ were computed. The results are shown in Table III.

TABLE III
Phonon schemes and infidelities for XX gate between ion pair (2,5) as
a function of gate time τ in μs. All infidelities are in units of 10⁻⁴.

| τ | 100 | 200 | 300 | 400 | 500 | 600 |
|---|---|---|---|---|---|---|
| phonon | 2255111 | 4522111 | 2621111 | 2621111 | 2621111 | 2621111 |
| scheme | | | | | | |
| F̅_{S} | 3.1 | 2.6 | 4.0 | 1.9 | 2.5 | 1.7 |
| F̅_{G} | 2.4 | 2.1 | 3.1 | 1.5 | 2.0 | 1.3 |
| F̅_{P} | 3.0 | 2.6 | 3.8 | 1.8 | 2.5 | 1.6 |
| Δ_{χ} | −0.012 | −0.011 | −0.011 | −0.011 | −0.011 | −0.011 |
| F̅_{S}^{c} | 1.6 | 1.5 | 2.9 | 0.78 | 1.4 | 0.61 |
| F̅_{G}^{c} | 1.3 | 1.2 | 2.2 | 0.56 | 1.1 | 0.47 |
| F̅_{P}^{c} | 1.6 | 1.5 | 2.7 | 0.70 | 1.4 | 0.58 |
| F̅_{S}^{Φ, c} | 0.88 | 0.14 | 0.62 | 0.41 | 0.34 | 0.45 |
| F̅_{G}^{Φ, c} | 0.67 | 0.10 | 0.36 | 0.28 | 0.26 | 0.34 |
| F̅_{P}^{Φ, c} | 0.84 | 0.12 | 0.45 | 0.34 | 0.32 | 0.42 |

Accepting Ĥ_{MS} as a good approximation of Ĥ_{R}, the most important result from Table III is that a gate infidelity F̅_{G}<10⁻⁴ cannot be achieved if the control pulses g(t) are constructed on the basis of the standard Hamiltonian Ĥ_{S}. Nevertheless, while not quite meeting the goal of ≤10⁻⁴, the infidelities obtained are very close to this goal. It can also be seen that the three different infidelity measures, i.e., the state infidelity F̅_{S}, the average gate infidelity F̅_{G}, and the process infidelity F̅_{P} yield similar results and any one of them may be used as a proxy for assessing the infidelity of the two-qubit XX gate.

Next, the control pulse g(t) will be fixed using the 300 μs pulse from Table III and the quality of the various approximations Ĥ_{M}^{(N}^{_{c}}^{,N}^{ₛ}⁾ is determined with respect to the full Hamiltonian Ĥ_{MS} by computing the process infidelity \hat{F}_{P} for some of the Hamiltonians Ĥ_{M}^{(N}^{_{c}}^{,N}^{ₛ}⁾. The result is shown in Table IV. It can be seen that, expectedly, F̅_{P}<<10⁻⁴ for Ĥ_{M}^{-2,1)}=Ĥ_{S}, since in this case the pulse is generated on the basis of the standard Hamiltonian Ĥ_{S} and the gate simulator is controlled by the standard Hamiltonian Ĥ_{S} as well. So, perfect fidelity is ideally expected. The difference from zero in Table IV in this case is not due to the accuracy of the numerical integrator, which, as stated in Section V is of the order of 10⁻⁷, but is due to the phonon scheme. Including more phonon states in the basis increases the accuracy of the simulations and drives the infidelity in the case of Ĥ_{M}^{N}^{_{c}}^{=-2,N}^{ₛ}⁼¹⁾=Ĥ_{S} closer to zero. The table entry for (N_{c}=−2, Nₛ=1) also provides us with an estimate of the accuracy of the infidelity entries in Tables III and IV. As indicated by the (N_{c}=−2, Nₛ=1) entry in Table IV, the chosen phonon schemes guarantee an accuracy of the computed infidelities of approximately 3×10⁻⁵.

TABLE IV
Process infidelities F̅_{P} in units of 10⁻⁴ for phonon
scheme 2621111 and ion pair (2, 5) produced by model
Hamiltonians H_{M}^{(N}^{_{c}}^{, N}^{ₛ}⁾. A dash in the table means that
the corresponding quantity was not computed.

| | Nₛ = 1 | Nₛ = 3 | Nₛ = 5 | Nₛ = ∞ |
|---|---|---|---|---|
| N_{c} = −2 | 0.31 | 1.6 | 1.6 | 1.6 |
| N_{c} = 0 | 2.5 | 3.8 | 3.8 | — |
| N_{c} = 2 | 2.5 | 3.8 | 3.8 | — |
| N_{c} = ∞ | — | — | — | 3.8 |

Looking at the infidelity results in Table IV for the Hamiltonians expanded to zeroth and second orders in the cos-term in (5), it can be seen that neglecting the zeroth-order term in (5) (the carrier term) is not justified. But it can also be seen that, apparently, expansion to second order of the cos-term of (5) is not necessary. This is shown analytically in more detail in Sections IX. B. and IX. C.

Turning now to the expansions of the sin-term of (5), Table IV shows that truncating this expansion at the first order of the sin function, i.e., linearizing the sin-term in the Lamb-Dicke parameters, is not accurate enough. As a consequence, the expansion of the sin term in (5) has to be carried to the third order in the Lamb-Dicke parameters, but expansion to the 5th order is not necessary.

As an overall result of the performance tests for different (N_{c}, Nₛ) model Hamiltonians, Ĥ_{M}^{(0,3)} is a good enough approximation of Ĥ_{MS} on the ≤10⁻⁴ fidelity level. Conversely, the important result is that pulse construction on the basis of the standard Hamiltonian Ĥ_{S}=Ĥ_{M}^{(-2,1)} does not yield infidelities <10⁻⁴. Thus, to improve control-pulse construction, at a minimum, the carrier term [zeroth-order cos term in (5)] and the third-order sin term in (5) needed to be included. In Sections IX. B. and IX. C., the effects of these two additional Hamiltonian terms are further explored. It can also be seen analytically that inclusion of the second- and fourth-order terms of the Hamiltonian (5) are not needed.

### VIII. Calibration

Table III shows that the gate angle error Δχ is quite large and may make a significant contribution to the infidelity. However, by slightly adjusting the amplitude of the control pulse g(t), the gate angle error Δχ can be completely eliminated and thus any contribution to the infidelity that otherwise would be due to the gate angle error Δχ can be eliminated. Adjusting the pulse function g(t) to result in Δχ=0 is called calibration. This procedure, extensively used in the laboratory, is an attractive way of reducing the infidelity, since the phase-space closure condition (14) linear in the amplitude of the control pulse g(t), is invariant under a change in the control-pulse amplitude. So, despite calibration of the pulse, phase-space closure is always guaranteed exactly, independent of the pulse amplitude.

The error operator for the gate angle error Δχ is Ê=Δχ\hat{σ}ₓ⁽¹⁾\hat{σ}ₓ⁽²⁾, which trivially commutes with \hat{σ}ₓ⁽¹⁾\hat{σ}ₓ⁽²⁾. Therefore, for all entries in Table III, the contribution of the gate angle error Δχ to the state infidelity F_{S} may be estimated according to (35) and (36) as:

$${\overline{{F}_{S}}}^{( Δ χ )} = {( Δ χ )}^{2} [ 1 - {〈 {ψ}_{0} \vert {σ}_{x}^{( 1 )} {σ}_{x}^{( 2 )} \vert {ψ}_{0} 〉}^{2} ] . \qquad ( 57 )$$

Based on this result, and for all pulse lengths listed in Table III, F̅_{S}^{(Δχ)}˜1.2×10⁻⁴ is obtained, which makes a significant contribution to the infidelities listed in Table III. However, as mentioned above, this infidelity may be eliminated by calibrating the control pulse. Denoting by χ_{target} the desired gate angle and by χ_{g}=χ_{target}+Δχ the gate angle actually obtained with the control pulse g(t), the calibration factor c, i.e., the (real) factor by which the amplitude of g(t) has to be multiplied to eliminate the gate angle error Δχ is obtained explicitly, with (15), as:

$$c = {( {χ}_{target} / {χ}_{g} )}^{1 / 2} = {( \frac{{χ}_{t a r g e t}}{{χ}_{t a r get} + Δχ} )}^{1 / 2} . \qquad ( 58 )$$

The entries for the state infidelity F̅_{S}^{c}, the gate infidelity F̅_{G}^{c}, and the process infidelity F̅_{P}^{c} in Table III represent the results for the respective infidelities computed with the same control pulses used for the corresponding entries F̅_{S}, F̅_{G}, and F̅_{P}, but multiplied (calibrated) with the calibration factor c, computed according to (58) with the corresponding gate angle error Δχ values from Table III and χ_{target}=π/4. As expected, the result is a significant reduction of the infidelity. Since the starting state |ψ₀ [symbol] for the results in Table III is |ψ₀ [symbol] =|00 [symbol] |0 [symbol] ₚₕ, a reduction by Δχ² can be expected. This agrees well with the results in Table III. Since they can no longer be due to the gate angle error Δχ, the rest of the infidelities in Table III have to come from other sources. To look for these sources, the XX-gate propagator can be computed via a Magnus expansion as outlined in the following section.

### IX. Magnus Expansion

Given the time-dependent Schrödinger equation:

$$i \frac{\partial }{\partial t} \vert ψ ( t ) 〉 = \hat{H} ( t ) \vert ψ ( t ) 〉 , \qquad ( 59 )$$

the time evolution operator Û(τ) of (59) over the time interval τ may be constructed systematically and analytically, using a Magnus expansion, i.e., up to 3rd order in the Hamiltonian:

$$\hat{U} ( τ ) = exp [ i {\hat{W}}_{1} ( τ ) + i {\hat{W}}_{2} ( τ ) + i {\hat{W}}_{3} ( τ ) + … ] , \qquad ( 60 )$$

$$where$$

$${\hat{W}}_{1} ( τ ) = \frac{1}{i} {\int }_{0}^{τ} ( - ) \hat{H} ( {t}_{1} ) d {t}_{1} , \qquad ( 61 )$$

$${\hat{W}}_{2} ( τ ) = \frac{1}{2 i} {\int }_{0}^{τ} d {t}_{1} {\int }_{0}^{{t}_{1}} d {t}_{2} [ ( - ) \hat{H} ( {t}_{1} ) , ( - ) \hat{H} ( {t}_{2} ) ] ,$$

$${\hat{W}}_{3} ( τ ) = \frac{1}{6 i} {\int }_{0}^{τ} d {t}_{1} {\int }_{0}^{{t}_{1}} d {t}_{2} {\int }_{0}^{{t}_{2}} d {t}_{3} \{ [ ( - ) \hat{H} ( {t}_{1} ) , [ ( - ) \hat{H} ( {t}_{2} ) , ( - ) \hat{H} ( {t}_{3} ) ] ] + [ ( - ) \hat{H} ( {t}_{3} ) , [ ( - ) \hat{H} ( {t}_{2} ) , ( - ) \hat{H} ( {t}_{1} ) ] ] \}$$

are Hermitian operators.

In this section, a consistent Magnus expansion up to 4th order in the Lamb-Dicke parameters ηₚ^{j} is shown. Therefore, expanding the cosine-term in (5) up to fourth order in \hat{V}² and the sine-term in (5) up to third order in \hat{V}ⱼ, the Hamiltonian:

$$\hat{H} ( t ) = g ( t ) {\sum }_{α = 0}^{4} {\hat{h}}_{α} ( t ) \qquad ( 62 )$$

is used in the Magnus expansion (61), where

$$\begin{matrix}{\hat{h}}_{0} ( t ) = {\sum }_{j} {σ}_{y}^{( j )} , \\ {\hat{h}}_{1} ( t ) = {\sum }_{j} \hat{{V}_{j}} ( t ) {\hat{σ}}_{x}^{( j )} , \\ {\hat{h}}_{2} ( t ) = - \frac{1}{2} {\sum }_{j} {\hat{V}}_{j}^{2} ( t ) {\hat{σ}}_{y}^{( j )} , \\ {\hat{h}}_{3} ( t ) = - \frac{1}{6} {\sum }_{j} {\hat{V}}_{j}^{3} ( t ) {\hat{σ}}_{x}^{( j )} , \\ {\hat{h}}_{4} ( t ) = \frac{1}{24} {\sum }_{j} {\hat{V}}_{j}^{4} ( t ) {\hat{σ}}_{y}^{( j )} .\end{matrix} \qquad ( 63 )$$

It should be noted that ĥ₀(t) is actually time independent, but the time argument is formally kept for notational convenience. Based on the results listed in Table IV, it is known that the zeroth order of cos[\hat{V}ⱼ(t)] contributes substantially to the infidelity, while the 2nd and higher orders of cos[\hat{V}ⱼ(t)] do not, and that the first and third orders of sin[\hat{V}ⱼ(t)] contribute substantially, while the 5th and higher orders do not. Thus, the Hamiltonian (62) covers all these important cases. According to Table IV, it may not be necessary to include the second- and fourth-order expansion terms of the cosine function in (5). However, for a consistent expansion up to fourth order in the Lamb-Dicke parameters, and also to show that these terms are negligible, they are included in the expansion (62) of (5).

In Section IX. A., Ŵ₁(τ) is computed on the basis of (62). In Sections IX.B. and IX.C., Ŵ₂(τ) and Ŵ₃(τ), respectively are constructed. Many of the resulting error terms are found to be negligible. Further, the most significant terms that make significant contributions to the infidelity are identified.

With the operators defined in (63), the following Hermitian operators are defined:

$${\hat{T}}_{α} = - {\int }_{0}^{τ} {\hat{h}}_{α} ( t ) g ( t ) d t , α = 0,1,2,3,4, \qquad ( 64 )$$

$${\hat{T}}_{αβ} = - \frac{1}{2 i} {\int }_{0}^{τ} d {t}_{1} {\int }_{0}^{{t}_{1}} d {t}_{2} g ( {t}_{1} ) g ( {t}_{2} ) [ {\hat{h}}_{α} ( {t}_{1} ) , {\hat{h}}_{β} ( {t}_{2} ) ] , α , β = 0,1,2,3,4, \qquad ( 65 )$$

$$and$$

$${\hat{T}}_{a β γ} = ( \frac{1}{6} ) {\int }_{0}^{τ} d {t}_{1} {\int }_{0}^{{t}_{1}} d {t}_{2} {\int }_{0}^{{t}_{2}} d {t}_{3} g ( {t}_{1} ) g ( {t}_{2} ) g ( {t}_{3} ) \{ [ {\hat{h}}_{α} ( {t}_{1} ) , [ {\hat{h}}_{β} ( {t}_{2} ) ] , {\hat{h}}_{γ} ( {t}_{3} ) ] + [ {\hat{h}}_{a} ( {t}_{3} ) , [ {\hat{h}}_{β} ( {t}_{2} ) ] , {\hat{h}}_{γ} ( {t}_{1} ) ] \} , α , β , γ = 0,1,2,3,4 . \qquad ( 66 )$$

In the following sections, these operators are used (i) to compute Ŵ₁, Ŵ₂, and Ŵ₃ and (ii) to compute infidelity contributions to the gate evolution operator Û(τ) defined in (60).

### IX. A. First Order

With the definition in (64) Ŵ₁(τ) becomes:

$${\hat{W}}_{1} ( τ ) = {\sum }_{α = 0}^{4} {\hat{T}}_{α} ( τ ) , \qquad ( 67 )$$

where the carrier condition (13) together with

$${\int }_{0}^{τ} g ( t ) {e}^{i {ω}_{p} t} d t = 0 ⇒ {\int }_{0}^{τ} g ( t ) {\hat{V}}_{j} ( t ) d t = 0 , \qquad ( 68 )$$

is used to arrive at

$${\hat{T}}_{0} ( τ ) = 0 , \qquad ( 69 )$$

$${\hat{T}}_{1} ( τ ) = 0 , \qquad ( 70 )$$

$${\hat{T}}_{2} ( τ ) = ( \frac{1}{2} ) {\sum }_{p q j} {η}_{p}^{j} {η}_{q}^{j} {\hat{σ}}_{y}^{( j )} [ Q ( {ω}_{p} + {ω}_{q} ) {\hat{a}}_{p}^{†} {\hat{a}}_{q}^{†} + h . c . ] + {\sum }_{p q j , p \neq q} {η}_{p}^{j} {η}_{q}^{j} {\hat{σ}}_{y}^{( j )} Q ( {ω}_{p} - {ω}_{q} ) {\hat{a}}_{p}^{†} {\hat{a}}_{q} , \qquad ( 71 )$$

$${\hat{T}}_{3} ( τ ) = \frac{1}{6} {\sum }_{j = 1 , 2} {\hat{σ}}_{x}^{( j )} {\int }_{0}^{τ} g ( t ) {\hat{{V}_{j}}}^{3} ( t ) dt = \frac{1}{6} {\sum }_{p , q , r , j} {η}_{p}^{j} {η}_{q}^{j} {η}_{r}^{j} {\hat{σ}}_{x}^{( j )} \{ Q ( {ω}_{p} + {ω}_{q} + {ω}_{r} ) {\hat{a}}_{p}^{†} {\hat{a}}_{q}^{†} {\hat{a}}_{r}^{†} + Q ( {ω}_{p} + {ω}_{q} - {ω}_{r} ) {\hat{a}}_{p}^{†} {\hat{a}}_{q}^{†} {\hat{a}}_{r} + Q ( {ω}_{p} - {ω}_{q} + {ω}_{r} ) {\hat{a}}_{p}^{†} {\hat{a}}_{q} {\hat{a}}_{r}^{†} + Q ( - {ω}_{p} + {ω}_{q} + {ω}_{r} ) {\hat{a}}_{p} {\hat{a}}_{q}^{†} {\hat{a}}_{r}^{†} + h . c . \} , \qquad ( 72 )$$

$$and$$

$${\hat{T}}_{4} ( τ ) = ( - \frac{1}{24} ) {\sum }_{j} {\hat{σ}}_{y}^{( j )} {\int }_{0}^{τ} g ( t ) {\hat{{V}_{j}}}^{4} ( t ) dt = ( - \frac{1}{24} ) {\sum }_{j} {\hat{σ}}_{y}^{( j )} {\int }_{0}^{τ} g ( t ) {\sum }_{p q r s} {η}_{p}^{j} {η}_{q}^{j} {η}_{r}^{j} {η}_{s}^{j} \{ {\hat{a}}_{p}^{†} {\hat{a}}_{q}^{†} {\hat{a}}_{r}^{†} {\hat{a}}_{s}^{†} {e}^{i ( {ω}_{p} + {ω}_{q} + {ω}_{r} + {ω}_{s} ) t} + {\hat{a}}_{p}^{†} {\hat{a}}_{q}^{†} {\hat{a}}_{r}^{†} {\hat{a}}_{s} {e}^{i ( {ω}_{p} + {ω}_{q} + {ω}_{r} - {ω}_{s} ) t} … \} , \qquad ( 73 )$$

where Q(w), defined in (22), is used, in particular, with the carrier condition (13), Q(0)=0.

While \hat{T}₀(τ) and \hat{T}₁(τ) vanish, \hat{T}₂(τ), \hat{T}₃(τ), and \hat{T}₄(τ) need to be investigated further since they may produce undesirable contributions to the infidelity of the XX gate.

According to (71), the size of \hat{T}₂(τ) is controlled by

$${γ}_{2} = {max}_{pqj , σ = \pm 1} \vert {η}_{p}^{j} {η}_{q}^{j} Q ( {ω}_{p} + σ {ω}_{q} ) \vert . \qquad ( 74 )$$

Numerically, for the 300 μs test pulse,

$${γ}_{2} = 3.5 \times 1 {0}^{- 6} , \qquad ( 75 )$$

was obtained. Since γ₂ is significantly smaller than 10⁻⁴, \hat{T}₂(τ) may be neglected. According to (72), the size of \hat{T}₃(τ) is controlled by

$${γ}_{3}^{( + )} = ( \frac{1}{6} ) {max}_{pqrj} \vert {η}_{p}^{j} {η}_{q}^{j} {η}_{r}^{j} Q ( {ω}_{p} + {ω}_{q} + {ω}_{r} ) \vert \qquad ( 76 )$$

$$and$$

$$\begin{matrix}{γ}_{3}^{( - )} = ( \frac{1}{6} ) {max}_{pqrj} \vert {η}_{p}^{j} {η}_{q}^{j} {η}_{r}^{j} Q ( {ω}_{p} + {ω}_{q} - {ω}_{r} ) \vert \\ = ( \frac{1}{6} ) {max}_{pqrj} \vert {η}_{p}^{j} {η}_{q}^{j} {η}_{r}^{j} Q ( {ω}_{p} - {ω}_{q} + {ω}_{r} ) \vert \\ = ( \frac{1}{6} ) {max}_{pqrj} \vert {η}_{p}^{j} {η}_{q}^{j} {η}_{r}^{j} Q ( - {ω}_{p} + {ω}_{q} + {ω}_{r} ) \vert .\end{matrix} \qquad ( 77 )$$

For the 300 μs test pulse,

$${γ}_{3}^{( + )} = 5.8 \times 1 {0}^{- 8} , \qquad ( 78 )$$

$${γ}_{3}^{( - )} = 3.1 \times 1 {0}^{- 4} ,$$

was obtained. Since \hat{σ}ₓ^{(j)} commutes with \hat{σ}x⁽¹⁾\hat{σ}ₓ⁽²⁾, (35) may be used to estimate the infidelity F̅_{S}^{(T}^{₃}⁾) caused by \hat{T}₃(τ). Since, according to (78), both γ₃⁽⁺⁾ and γ₃⁽⁻⁾ are smaller than 10⁻³, and since F̅_{S}^{(T}^{₃}⁾, according to (35), involves the square of \hat{T}₃(τ), the infidelity caused by \hat{T}₃(τ) is negligible on the level of 10⁻⁴.
According to (73), the size of \hat{T}₄(τ) is controlled by

$${γ}_{4} = {{max}_{j , pqrs}}_{{σ}_{p} {σ}_{q} {σ}_{r} {σ}_{s} = \pm 1} \vert {η}_{p}^{j} {η}_{q}^{j} {η}_{r}^{j} {η}_{s}^{j} Z ( {σ}_{p} {ω}_{p} , {σ}_{q} {ω}_{q} + {σ}_{r} {ω}_{r} + {σ}_{s} {ω}_{s} ) \vert . \qquad ( 79 )$$

For the 300 μs test pulse,

$${γ}_{4} = 1.1 \times 1 {0}^{- 7} , \qquad ( 80 )$$

was obtained. Therefore, \hat{T}₄(τ) can be neglected.

As a result of this section it has been found that, on the 10⁻⁴ level, the first-order terms in the Magnus expansion do not contribute to the infidelity. However, it should be noted that this is only true if the pulse function g(t) satisfies the carrier condition (13). Thus, the carrier condition (13) is an important condition that needs to be required for high-fidelity XX gates.

### IX. B. Second Order

Now, the second-order terms (65) are evaluated in the Magnus expansion, i.e., Ŵ₂(τ) is computed analytically for Ĥ(t) defined in (62) up to fourth order in the Lamb-Dicke parameters η. With the definitions (65) of the operators \hat{T}_{αβ}(τ), the definition (15) of the gate angle, making use of the carrier condition (13), and the functions defined in (16)-(28),

$${\hat{W}}_{2} ( τ ) = {\sum }_{α , β = 0}^{4} {\hat{T}}_{αβ} ( τ ) , \qquad ( 81 )$$

was obtained, where the operators \hat{T}_{αβ}, listed only up to fourth order in η, are

$${\hat{T}}_{00} = 0 , \qquad ( 82 )$$

$$\begin{matrix}{\hat{T}}_{01} = - {\sum }_{j = 1 , 2} {\hat{σ}}_{z}^{( j )} {\int }_{0}^{τ} g ( t ) G ( t ) \hat{{V}_{j}} ( t ) dt \\ = - {\sum }_{jp} {η}_{p}^{j} {\hat{σ}}_{z}^{( j )} [ f ( {ω}_{p} ) {\hat{a}}_{p}^{†} + {f}^{*} ( {ω}_{p} ) {\hat{a}}_{p} ] ,\end{matrix} \qquad ( 83 )$$

$${\hat{T}}_{02} = 0 , \qquad ( 84 )$$

$$\begin{matrix}{\hat{T}}_{03} = ( \frac{1}{6} ) {\sum }_{j = 1 , 2} {\hat{σ}}_{z}^{( j )} {\int }_{0}^{τ} g ( t ) G ( t ) {\hat{{V}_{j}}}^{3} ( t ) dt \\ = ( \frac{1}{6} ) {\sum }_{pqrj} {\hat{σ}}_{z}^{( j )} {η}_{p}^{j} {η}_{q}^{j} {η}_{r}^{j} \{ f ( {ω}_{p} + {ω}_{q} + {ω}_{r} ) {\hat{a}}_{p}^{†} {\hat{a}}_{q}^{†} {\hat{a}}_{r}^{†} + \\ f ( {ω}_{p} + {ω}_{q} - {ω}_{r} ) {\hat{a}}_{p}^{†} {\hat{a}}_{q}^{†} {\hat{a}}_{r}^{†} \\ + f ( {ω}_{p} - {ω}_{q} + {ω}_{r} ) {\hat{a}}_{p}^{†} {\hat{a}}_{q} {\hat{a}}_{r}^{†} + f ( - {ω}_{p} + {ω}_{q} + {ω}_{r} ) {\hat{a}}_{p} {\hat{a}}_{q}^{†} {\hat{a}}_{r}^{†} + h . c . \} ,\end{matrix} \qquad ( 85 )$$

$${\hat{T}}_{04} = 0 ,$$

$${\hat{T}}_{10} = {\hat{T}}_{01} , \qquad ( 87 )$$

$${\hat{T}}_{11} = \tilde{χ} + χ {\hat{σ}}_{x}^{( 1 )} {\hat{σ}}_{x}^{( 2 )} , \qquad ( 88 )$$

$${\hat{T}}_{12} = ( \frac{1}{4} ) {\sum }_{j} {\hat{σ}}_{z}^{( j )} {\int }_{0}^{τ} {dt}_{1} {\int }_{0}^{{t}_{1}} {dt}_{2} g ( {t}_{1} ) g ( {t}_{2} ) \{ {\hat{V}}_{j} ( {t}_{1} ) , {\hat{{V}_{j}}}^{2} ( {t}_{2} ) \} - {\sum }_{pq , j \neq k} {η}_{p}^{j} {η}_{p}^{k} {η}_{q}^{k} {\hat{σ}}_{x}^{( j )} {\hat{σ}}_{y}^{( k )} [ {S}_{p} ( {ω}_{q} ) {\hat{a}}_{q}^{†} + {S}_{p}^{*} ( {ω}_{q} ) {\hat{a}}_{q} ] , \qquad ( 89 )$$

$$\begin{matrix}{\hat{T}}_{13} = ( - \frac{1}{2} ) {\sum }_{jkp} {\hat{σ}}_{x}^{( j )} {\hat{σ}}_{x}^{( k )} {η}_{p}^{j} {η}_{p}^{k} {\int }_{0}^{τ} {dt}_{1} {\int }_{0}^{{t}_{1}} \\ {dt}_{2} g ( {t}_{1} ) g ( {t}_{2} ) sin [ {ω}_{p} ( {t}_{1} - {t}_{2} ) ] {\hat{V}}_{j}^{2} ( {t}_{1} ) \\ = ( - \frac{1}{2} ) {\sum }_{jkpqr} {\hat{σ}}_{x}^{0 )} {\hat{σ}}_{x}^{( k )} {η}_{p}^{j} {η}_{p}^{k} {η}_{q}^{j} {η}_{r}^{j} [ {S}_{p} ( {ω}_{q} + {ω}_{r} ) {\hat{a}}_{q}^{†} {\hat{a}}_{r}^{†} \\ + {S}_{p} ( {ω}_{q} - {ω}_{r} ) {\hat{a}}_{q}^{†} {\hat{a}}_{r} + {S}_{p}^{*} ( {ω}_{q} - {ω}_{r} ) {\hat{a}}_{q} {\hat{a}}_{r}^{†} + {S}_{p}^{*} ( {ω}_{q} + {ω}_{r} ) {\hat{a}}_{q} {\hat{a}}_{r} ] ,\end{matrix} \qquad ( 90 )$$

$${\hat{T}}_{20} = 0 , \qquad ( 91 )$$

$${\hat{T}}_{21} = {\hat{T}}_{12} , \qquad ( 92 )$$

$${\hat{T}}_{22} = ( \frac{1}{2} ) {\sum }_{jkp} {η}_{p}^{j} {η}_{p}^{k} {\hat{σ}}_{y}^{( j )} {\hat{σ}}_{y}^{( k )} {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] \{ {\hat{V}}_{j} ( {t}_{1} ) , {\hat{V}}_{k} ( {t}_{2} ) \} , \qquad ( 93 )$$

$${\hat{T}}_{30} = {\hat{T}}_{03} , \qquad ( 94 )$$

$${\hat{T}}_{31} = {\hat{T}}_{13} , \qquad ( 95 )$$

$$and$$

$${\hat{T}}_{40} = 0. \qquad ( 96 )$$

The above explicit, analytical results are computed making explicit use of the carrier condition (13).

Since \hat{χ} in (88) is only a c-number, which causes only a global phase, \hat{T}₁₁ generates the desired XX gate. All the other operators \hat{T}_{αβ} in (82)-(96), if not identically zero, are unwanted error operators that generate infidelities. Because of symmetries and the operators that are identically zero, the sizes of only five remaining, non-zero error operators, i.e., \hat{T}₀₁, \hat{T}₀₃, \hat{T}₁₂, \hat{T}₁₃, and \hat{T}₂₂ need to be investigated.

The size of \hat{T}₀₁ is controlled by

$${γ}_{01} = {max}_{pj} \vert {η}_{p}^{j} f ( {ω}_{p} ) \vert . \qquad ( 97 )$$

For the 300 μs test pulse

$${γ}_{01} = 1.8 \times 1 {0}^{- 6} , \qquad ( 98 )$$

was obtained. Thus, on the 10⁻⁴ level, \hat{T}₀₁ can safely be neglected.

Next, \hat{T}₀₃ is evaluated, which proceeds in analogy to the evaluation of \hat{T}₃(τ) in Section IX. A. The size of \hat{T}₀₃ is controlled by

$${γ}_{03}^{( + )} = ( \frac{1}{6} ) {max}_{pqrj} \vert {η}_{p}^{j} {η}_{q}^{j} {η}_{r}^{j} f ( {ω}_{p} + {ω}_{q} + {ω}_{r} ) \vert \qquad ( 99 )$$

$$and$$

$$\begin{matrix}{γ}_{03}^{( - )} = ( \frac{1}{6} ) {max}_{pqrj} \vert {η}_{p}^{j} {η}_{q}^{j} {η}_{r}^{j} f ( {ω}_{p} + {ω}_{q} - {ω}_{r} ) \vert \\ = ( \frac{1}{6} ) {max}_{pqrj} \vert {η}_{p}^{j} {η}_{q}^{j} {η}_{r}^{j} f ( {ω}_{p} - {ω}_{q} + {ω}_{r} ) \vert \\ = ( \frac{1}{6} ) {max}_{pqrj} \vert {η}_{p}^{j} {η}_{q}^{j} {η}_{r}^{j} f ( - {ω}_{p} + {ω}_{q} + {ω}_{r} ) \vert .\end{matrix} \qquad ( 100 )$$

For the 300 μs test pulse,

$${γ}_{03}^{( + )} = 7.4 \times 1 {0}^{- 10} , \qquad ( 101 )$$

$${γ}_{03}^{( - )} = 9.3 \times 1 {0}^{- 10} ,$$

was obtained. Thus, \hat{T}₀₃ is negligible.
According to (89), the operator \hat{T}₁₂ consists of two parts, an anti-commutator part and a part that originated from a commutator. The size of the anti-commutator part of \hat{T}₁₂ is controlled by

$${γ}_{12}^{( a )} = {{max}_{j , pqr}}_{{σ}_{p} {σ}_{q} {σ}_{r} = \pm 1} \vert {η}_{p}^{j} {η}_{q}^{j} {η}_{r}^{j} Z ( {σ}_{p} {ω}_{p} , {σ}_{q} {ω}_{q} + {σ}_{r} {ω}_{r} ) \vert . \qquad ( 102 )$$

The commutator part is controlled by

$${γ}_{12}^{( c )} = {max}_{pq , j \neq k} \vert {η}_{p}^{j} {η}_{p}^{k} {η}_{q}^{k} {S}_{p} ( {ω}_{q} ) \vert . \qquad ( 103 )$$

For the 300 μs test pulse both turned out to be very small. Thus, \hat{T}₁₂ can be neglected.

The operator \hat{T}₁₃ in (90) can be split into a diagonal part

$${\hat{T}}_{13}^{( d )} = ( - \frac{1}{2} ) {\sum }_{jpqr} {( {η}_{p}^{j} )}^{2} {η}_{q}^{j} {η}_{r}^{j} [ {S}_{p} ( {ω}_{q} + {ω}_{r} ) {\hat{a}}_{q}^{†} {\hat{a}}_{r}^{†} + {S}_{p} ( {ω}_{q} - {ω}_{r} ) {\hat{a}}_{q}^{†} {\hat{a}}_{r} + {S}_{p}^{*} ( {ω}_{q} - {ω}_{r} ) {\hat{a}}_{q} {\hat{a}}_{r}^{†} + {S}_{p}^{*} ( {ω}_{q} + {ω}_{r} ) {\hat{a}}_{q} {\hat{a}}_{r} ] \qquad ( 104 )$$

and an off-diagonal part

$${\hat{T}}_{13}^{( o )} = ( - \frac{1}{2} ) {\sum }_{jkpqr} {\hat{σ}}_{x}^{( 1 )} {\hat{σ}}_{x}^{( 2 )} {η}_{p}^{( 1 )} {η}_{p}^{( 2 )} [ {η}_{q}^{( 1 )} {η}_{r}^{( 1 )} + {η}_{q}^{( 2 )} {η}_{r}^{( 2 )} ] [ {S}_{p} ( {ω}_{q} + {ω}_{r} ) {\hat{a}}_{q}^{†} {\hat{a}}_{r}^{†} + {S}_{p} ( {ω}_{q} - {ω}_{r} ) {\hat{a}}_{q}^{†} {\hat{a}}_{r} + {S}_{p}^{*} ( {ω}_{q} - {ω}_{r} ) {\hat{a}}_{q} {\hat{a}}_{r}^{†} + {S}_{p}^{*} ( {ω}_{q} + {ω}_{r} ) {\hat{a}}_{q} {\hat{a}}_{r} ] . \qquad ( 105 )$$

The size of \hat{T}₃^{(d)} is controlled by

$${γ}_{13}^{( d )} = {max}_{\begin{matrix}j , pqr \\ σ = \pm 1\end{matrix}} \vert {( {η}_{p}^{j} )}^{2} {η}_{q}^{j} {η}_{r}^{j} {S}_{p} ( {ω}_{q} + {σω}_{r} ) \vert . \qquad ( 106 )$$

For the 300 μs test pulse,

$${γ}_{13}^{( d )} = 1.17 \times 1 {0}^{- 3} , \qquad ( 107 )$$

were obtained. Thus, compared to the target infidelity of <<10⁻⁴, \hat{T}₁₃^{(d)} cannot be dismissed outright. However, taking \hat{T}₁₃^{(d)} as the error operator and since \hat{T}₁₃^{(d)} commutes with σₓ⁽¹⁾αₓ⁽²⁾, the infidelity estimate (35) can be used, which involves the squares of \hat{T}₁₃^{(d)}, i.e., the contribution of \hat{T}₁₃^{(d)} to the infidelity of Û(τ) is expected to be of the order of (γ₁₃^{(d)})²˜10⁻⁶. This means that the contribution of \hat{T}₁₃^{(d)} to the infidelity of Û(τ) can be neglected.

The term \hat{T}₁₃^{(o)} contains σₓ⁽¹⁾σₓ⁽²⁾ and thus contributes to over/under rotation of the XX gate, i.e., it contributes to Δχ (see Table III). The operator \hat{T}₁₃^{(o)} acts in the computational space but also produces phonon excitations. However, according to (105), the two-phonon excitation terms are proportional to Sₚ(ω_{q}+ωᵣ), which are nonresonant and very small. Assuming that the initial state starts out in the phonon ground state, |0>ₚₕ, the operator \hat{T}₁₃^{(o)} is, to an excellent approximation,

$${\hat{T}}_{13}^{( 0 )} = ( - \frac{1}{2} ) {\sum }_{p q} {η}_{p}^{( 1 )} {η}_{p}^{( 2 )} [ {( {η}_{q}^{( 1 )} )}^{2} + {( {η}_{q}^{( 2 )} )}^{2} ] {σ}_{x}^{( 1 )} {σ}_{x}^{( 2 )} {S}_{p} ( 0 ) . \qquad ( 108 )$$

Now, with (15),

$${\sum }_{p} {η}_{p}^{( 1 )} {η}_{p}^{( 2 )} {S}_{p} ( 0 ) = {\sum }_{p} {η}_{p}^{( 1 )} {η}_{p}^{( 2 )} {\int }_{0}^{τ} d {t}_{1} {\int }_{0}^{{t}_{1}} d {t}_{2} g ( {t}_{1} ) g ( {t}_{2} ) sin [ {ω}_{p} ( {t}_{1} - {t}_{2} ) ] = \frac{χ}{2} . \qquad ( 109 )$$

With this result,

$${\hat{T}}_{13}^{( 0 )} = [ ( - \frac{χ}{4} ) {\sum }_{j p} {( {η}_{p}^{j} )}^{2} ] {σ}_{x}^{( 1 )} {σ}_{x}^{( 2 )} . \qquad ( 110 )$$

The prefactor of the αₓ⁽¹⁾σₓ⁽²⁾ operator is a c-number. Therefore, \hat{T}₁₃^{(o)} produces a contribution to the gate angle χ. Since \hat{T}₃₁=\hat{T}₁₃, the total contribution to the gate angle error Δχ is

$$Δ χ = ( - \frac{χ}{2} ) {\sum }_{j p} {( {η}_{p}^{j} )}^{2} . \qquad ( 111 )$$

Numerically, for the N=7 case (see Table II),

$${\sum }_{j p} {( {η}_{p}^{j} )}^{2} = 2.45 \times 1 {0}^{- 2} , \qquad ( 112 )$$

was obtained. For χ=π/4, this results in

$$Δ χ = - 9.62 \times 1 {0}^{- 3} . \qquad ( 113 )$$

According to the numerical simulations (see Table III), Δχ≈−0.011 is obtained. Thus, the analytical calculations predict the correct sign (under-rotation) of χ. In addition, the magnitude of the relative error of the analytical prediction is (0.011−9.62×10⁻³)/0.011≈0.13, i.e., the analytical prediction is only of the order of 10% off.

According to (111), Δχ depends only on the Lamb-Dicke parameters, and not on the gate duration τ. This is reflected in Table III and explains why Δχ in Table III is approximately constant, independent of τ.

Summarizing the results obtained in this Section, it is found that the second-order Magnus-expansion operators yield only two substantial contributions, i.e., the operator \hat{T}₁₁, which generates the desired XX gate and the operator 2\hat{T}₁₃ which explains the under-rotation of the gate angle, its approximate independence of the gate time τ, and, approximately, its size, as listed in Table Ill.

At the end of Section VIII, it is noted that Δχ explains a significant contribution to the infidelity of Û(τ), but cannot explain the entire infidelity contribution. Thus, the additional sources of infidelity in the various orders of the Magnus expansion were explored. In this section the Inventors have found that the second order explains only the origin of Δχ, but does not reveal any additional significant sources of infidelity. Since the second order of the Magnus expansion did not reveal these sources, the third order of the Magnus expansion is now investigated, which, indeed, reveals the remaining significant sources of infidelity. In addition, it will be found that this source of infidelity can be eliminated by the addition of a single linear equation to the control-pulse construction protocol.

### IX. C Third Order

In this section, Ŵ₃(τ) is computed. With the definitions (66) stated at the end of the introduction to Section IX,

$${\hat{W}}_{3} ( τ ) = {\sum }_{j k i} {\hat{T}}_{jkl} \qquad ( 114 )$$

was obtained. All operators \hat{T}ⱼₖₗ up to fourth order in η are listed in Section XIII. There is only a single operator of zeroth order in η, i.e., \hat{T}₀₀₀˜η⁰. It is trivially zero and does not contribute to the infidelity.

There are three operators of first order in η, i.e., \hat{T}₀₀₁, \hat{T}₀₁₀, \hat{T}₁₀₀, where [see Section XIII]\hat{T}₀₁₀=2\hat{T}₀₀₁, and \hat{T}₁₀₀=0. This means that only \hat{T}₀₀₁'s contribution to the infidelity has to be investigated. With (25), the infidelity caused by \hat{T}₀₀₁ is controlled by

$${γ}_{001} = {max}_{jp} \vert {η}_{p}^{j} {J}_{p} \vert . \qquad ( 115 )$$

For the 300 μs control pulse,

$${γ}_{001} = 1.2 \times 1 {0}^{- 6} , \qquad ( 116 )$$

was obtained. Therefore, \hat{T}₀₀₁, and with it \hat{T}₀₁₀, are negligible. Since \hat{T}₁₀₀=0, all operators ˜η¹ can be neglected.

There are six operators of second order in η, i.e., \hat{T}₀₀₂, \hat{T}₀₁₁, \hat{T}₀₂₀, \hat{T}₁₀₁, \hat{T}₁₁₀, and \hat{T}₂₀₀. Of these, according to Section XIII, only \hat{T}₀₁₁, \hat{T}₁₀₁, and \hat{T}₁₁₀ are nonzero, and of those, only \hat{T}₀₁₁ and \hat{T}₁₁₀ are non-negligible. While \hat{T}₀₁₁ acts only on the computational space, \hat{T}₁₁₀ also has a part that produces phonon excitations. This part, however, is negligibly small. As an overall result of the operators ˜η², it has been found that the effective error operator corresponding to the sum of the leading parts of \hat{T}₀₁₁ and \hat{T}₁₁₀ is:

$${\hat{E}}^{{σ}_{x} {σ}_{z}} = 4 Φ [ η , g ] [ {\hat{σ}}_{x}^{( 1 )} {\hat{σ}}_{z}^{( 2 )} + {\hat{σ}}_{x}^{( 2 )} {\hat{σ}}_{z}^{( 1 )} ] . \qquad ( 117 )$$

The inventors have checked that all operators of order three and four in η are negligible. Thus, (117) is the only significant error operator that results from the third-order Magnus expansion. It should be noted that this operator acts only in the computational space, not in the phonon space. With (50) and λ=4Φ[η, g], the infidelity contribution of (117) for |ψ₀ [symbol] =|00 [symbol] |0 [symbol] ₚₕ.

$${\overline{{F}_{S}}}^{( {σ}_{x} {σ}_{z} )} = {( \frac{λ sin ( χ )}{χ} )}^{2} 〈 {ψ}_{0} \vert [ {\hat{σ}}_{x}^{( 1 )} {\hat{σ}}_{z}^{( 2 )} + {\hat{σ}}_{x}^{( 2 )} {\hat{σ}}_{z}^{( 1 )} ] \vert {ψ}_{0} 〉 = {( \frac{4 λ}{π} )}^{2} , \qquad ( 118 )$$

was obtained. For the 300 μs test pulse,

$$λ = 1.17 \times 1 {0}^{- 2} , \qquad ( 119 )$$

was obtained. Thus, with (118),

$${\overline{{F}_{S}}}^{( {σ}_{x} {σ}_{z} )} = 2.2 \times 1 {0}^{- 4} , \qquad ( 120 )$$

was obtained. Together with (113), an estimate for the total infidelity of the 300 μs test pulse is obtained according to:

$${\overline{F}}_{S} = {( Δχ )}^{2} + {\overline{F}}_{S}^{( {σ}_{x} {σ}_{z} )} = {( - 9.62 \times {10}^{- 3} )}^{2} + 2.2 \times {10}^{- 4} = 3.1 \times {10}^{- 4} . \qquad ( 121 )$$

According to Table III, this accounts for about 80% of the infidelity of the 300 μs test pulse. Since, via calibration, Δχ can always be set to zero, generating control pulses that zero out the Φ functional may go a long way to reduce the infidelity. How to generate such control pulses, and that this recipe actually works to suppress the infidelity below 10⁻⁴, is shown in the following section.

### X. Improved Control-Pulse Construction

In Section VIII, it has been argued and proved numerically, that a significant portion of the infidelity can be removed by calibration of the control pulse. Here, it is shown that by eliminating the infidelity due to the Φ-functional (see Section IX. C.), the infidelity can be further suppressed below the level of 10⁻⁴. To eliminate Φ, the auxiliary condition:

$${\sum }_{n} \frac{{B}_{n}}{n} = 0 \qquad ( 122 )$$

is added to the AMFM pulse-solver code and obtain new pulses \tilde{g}(t) that zero out Φ[η, \tilde{g}], defined in (27). That the AMFM code with the condition (122) added produces control pulses \tilde{g}(t) with Φ[η, \tilde{g}]=0 was confirmed explicitly. As described in Section VIII, \tilde{g}(t) may be renormalized (calibrated) such that \tilde{g}(t) not only produces Φ[η, \tilde{g}]=0, but simultaneously produces Δχ=0. Running the gate-simulator code (see Section V) with the calibrated pulses \tilde{g}(t), the infidelities F̅_{S}^{Φ,c}, F̅_{G}^{Φ,c}, and F̅_{Φ}^{Φ,c} were found as shown in Table III. It can be sees that in all cases the calibrated pulses \tilde{g}(t) produce infidelities below 10⁻⁴. It should be noted that the calibrated pulses \tilde{g}(t) require only insignificantly larger power compared with the original pulses g(t). This is as expected, since only one additional condition, i.e., the auxiliary condition (122), was added to the original set of linear phase-space closure conditions (14). Thus, the computation of the pulse function g(t) involves a linear process of solving a set of linear equations with respect to the Fourier coefficients Bₙ. It should be noted that, in conjunction with calibration, the construction of the improved AMFM pulses \tilde{g}(t) is still a linear process. Nonlinear optimizer codes are not required.

### XI. Scaling

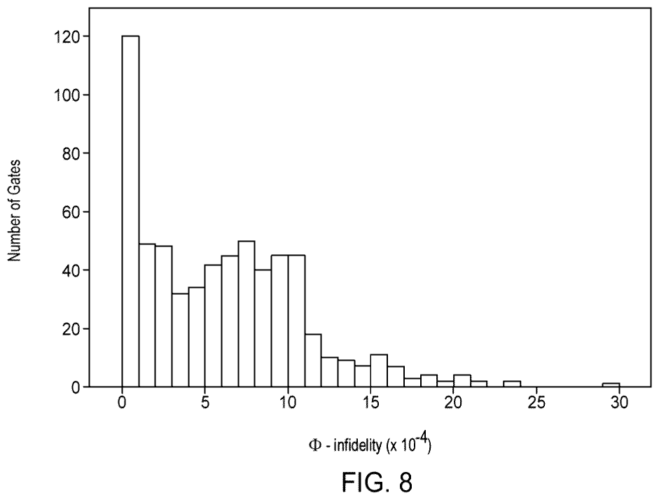

So far the 7-ion case has been discussed, for which a complete analysis machinery is in place consisting of pulse construction, analytical formulas for error estimates, and a gate simulator that includes all the relevant phonon states (see Section V). The analytical results do not depend on the number of ions N in the chain, i.e., the analytical results are valid for any number of qubits. In particular, as soon as a control pulse is generated (it does not matter whether this is an AM pulse, FM pulse, AMFM pulse, or any other type of pulse), this pulse can immediately be inserted into the analytical formulas, which then may be used to obtain infidelity estimates for this particular N-ion control pulse. This method is illustrated for N=36 by computing the infidelity (118), i.e., the leading source of infidelity, for N=36 uncalibrated control pulses for 2-qubit XX gates between all possible gate combinations (i₀, j₀), j₀=1, . . . , i₀−1, i₀=2, . . . ,36. This results in 630 gate combinations. The infidelities obtained are displayed in FIG. 8 in the form of a bar graph, where the height of a bar shows the frequency of occurrence of infidelities within the width of the bar. The infidelities in FIG. 8 are in units of 10⁻⁴=1 pptt, where the unit “pptt” denotes one part per ten thousand. It can be seen that the infidelities generated by N=36 control pulses constructed on the basis of the Standard Hamiltonian Ĥ_{S} are significant, and in many cases they are much larger than 10 pptt. This particular error source, in conjunction with calibration, can now be eliminated completely by using the linear construction technique outlined in Section X.

The histogram in FIG. 8 was made for 300 μs AMFM pulses. The question is: How does this scale with the gate time τ. To answer this question, 36-ion AMFM histograms at 700 μs were also computed. The result is that most of the Φ-infidelities for the 700 μs AMFM histogram are below 5 pptt. About half of the gates are good gates with infidelities less than 1 pptt and most of the other gates have Φ-infidelities less than 5 pptt. This indicates that the Φ-infidelity is a sensitive function of gate time τ.

### XII: Gate Simulator Matrix Elements

In this section, the matrix elements of the full Hamiltonian Ĥ_{MS} are presented as well as the ones of the model Hamiltonians Ĥ^{(N}^{_{c}}^{,N}^{ₛ}⁾. The matrix elements of the full Hamiltonian, Ĥ_{MS} are calculated.

The matrix elements of the cosine part of Ĥ_{MS} are

$${C}_{{n}_{1} {n}_{2} … ; {m}_{1} {m}_{2} …}^{( j )} = 〈 {n}_{1} {n}_{2} … \vert cos [ {\sum }_{p} {η}_{p}^{j} ( {\hat{a}}_{p}^{†} + {\hat{a}}_{p} ) ] \vert {m}_{1} {m}_{2} … 〉 = \frac{1}{2} 〈 {n}_{1} {n}_{2} … \vert {e}^{i {\sum }_{p} {η}_{p}^{i} ( {\hat{a}}_{p}^{†} + {\hat{a}}_{p} )} + {e}^{- i {\sum }_{p} {η}_{p}^{i} ( {\hat{a}}_{p}^{†} + {\hat{a}}_{p} )} \vert {m}_{1} {m}_{2} … 〉 = \frac{1}{2} \{ {\prod }_{p} 〈 {n}_{p} \vert {e}^{i {η}_{p}^{j} ( {\hat{a}}_{p}^{†} + {\hat{a}}_{p} )} \vert {m}_{p} 〉 + {\prod }_{p} 〈 {n}_{p} \vert {e}^{i {η}_{p}^{j} ( {\hat{a}}_{p}^{†} + {\hat{a}}_{p} )} \vert {m}_{p} 〉 \} . \qquad ( 123 )$$

It can be seen that Cₙ_{₁}ₙ_{₂}_{. . . ;m}_{₁}ₘ_{₂}_{. . .} ^{(j)} is real and symmetric in nₚ↔mₚ. With nₚ≥mₚ and

$$〈 n \vert {e}^{λ {\hat{a}}^{†}} \vert m 〉 = \{ \begin{matrix}0 & if m > n \\ {\frac{{λ}^{n - m}}{( n - m ) !} [ \frac{n !}{m !} ]}^{1 / 2} & if m \leq n ,\end{matrix} \qquad ( 124 )$$

$${C}_{{n}_{1} {n}_{2} … ; {m}_{1} {m}_{2} …}^{( j )} = \frac{1}{2} {\prod }_{p} {{e}^{- {( {η}_{p}^{j} )}^{2} / 2} ( \frac{{m}_{p} !}{{n}_{p} !} )}^{1 / 2} {( {η}_{p}^{j} )}^{{n}_{p} - {m}_{p}} {L}_{{m}_{p}}^{( {n}_{p} - {m}_{p} )} [ {( {η}_{p}^{j} )}^{2} ] \{ {\prod }_{p} {i}^{( {n}_{p} - {m}_{p} )} + {\prod }_{p} {( - i )}^{( {n}_{p} - {m}_{p} )} \} , \qquad ( 125 )$$

are obtained. Now, define

$$σ = [ {\sum }_{p} ( {n}_{p} - {m}_{p} ) ] mod 4. \qquad ( 126 )$$

### Then:

$${C}_{{n}_{1} {n}_{2} … ; {m}_{1} {m}_{2} …}^{( j )} = {\prod }_{p} {{e}^{- {( {η}_{p}^{j} )}^{2} / 2} ( \frac{{m}_{p} !}{{n}_{p} !} )}^{1 / 2} {( {η}_{p}^{j} )}^{{n}_{p} - {m}_{p}} {L}_{{m}_{p}}^{( {n}_{p} - {m}_{p} )} [ {( {η}_{p}^{j} )}^{2} ] \{ \begin{matrix}1 , & if σ = 0 , \\ 0 , & if σ = 1 , \\ - 1 , & if σ = 2 , \\ 0 , & if σ = 3.\end{matrix} \qquad ( 127 )$$

### Because of

$${C}_{{n}_{1} {n}_{2} … ; {m}_{1} {m}_{2} …}^{( j )} \sim {\prod }_{p} {( {η}_{p}^{j} )}^{{n}_{p} - {m}_{p}} , \qquad ( 128 )$$

and |ηₚ^{j}|<<1, it can be seen that Cₙ_{₁}ₙ_{₂}_{. . . ;m}_{₁}ₘ_{₂}_{. . .} ^{(j)} is very close to diagonal, i.e., only the first few off-diagonals are significantly different from zero. This fact can be used to speed up the numerical integration of the system of linear equations significantly.

### Similarly,

$${S}_{{n}_{1} {n}_{2} … ; {m}_{1} {m}_{2} …}^{( j )} = 〈 {n}_{1} {n}_{2} … \vert sin [ {\sum }_{p} {η}_{p}^{j} ( {\hat{a}}_{p}^{†} + {\hat{a}}_{p} ) ] \vert {m}_{1} {m}_{2} … 〉 = {\prod }_{p} {{e}^{- {( {η}_{p}^{j} )}^{2} / 2} ( \frac{{m}_{p} !}{{n}_{p} !} )}^{1 / 2} {( {η}_{p}^{j} )}^{{n}_{p} - {m}_{p}} {L}_{{m}_{p}}^{( {n}_{p} - {m}_{p} )} [ {( {η}_{p}^{j} )}^{2} ] \{ \begin{matrix}0 , & if σ = 0 , \\ 1 , & if σ = 1 , \\ 0 , & if σ = 2 , \\ - 1 , & if σ = 3 ,\end{matrix} \qquad ( 129 )$$

are obtained.

### XIII: Third-Order Commutators

In this section, the results of some third-order commutators Tⱼₖₗ as defined in (66) with η orders η^{m}, m≤4 are listed, grouped according to their η order m.

Commutators \hat{T}ⱼₖₗ˜η⁰:

$${\hat{T}}_{000} = 0 , \qquad ( 130 )$$

Commutators \hat{T}ⱼₖₗ˜η¹:

$${\hat{T}}_{001} = ( \frac{2}{3} ) {\sum }_{j = 1 , 2} [ {\int }_{0}^{τ} g ( t ) {G}^{2} ( t ) {\hat{V}}_{j} ( t ) dt ] {\hat{σ}}_{x}^{( j )} , \qquad ( 131 )$$

$${\hat{T}}_{010} = 2 {\hat{T}}_{001} , \qquad ( 132 )$$

$${\hat{T}}_{100} = 0 , \qquad ( 133 )$$

Commutators \hat{T}ⱼₖₗ˜η²:

$${\hat{T}}_{002} = 0 , \qquad ( 134 )$$

$${\hat{T}}_{011} = ( \frac{8}{3} ) Φ [ η , g ] [ {\hat{σ}}_{x}^{( 1 )} {\hat{σ}}_{z}^{( 2 )} + {\hat{σ}}_{x}^{( 2 )} {\hat{σ}}_{z}^{( 1 )} ] , \qquad ( 135 )$$

$${\hat{T}}_{020} = 0 , \qquad ( 136 )$$

$${\hat{T}}_{101} = ( - \frac{2}{3} ) {\sum }_{j = 1 , 2} {\hat{σ}}_{y}^{( j )} {\int }_{0}^{τ} {dt}_{1} {\int }_{0}^{{t}_{1}} {dt}_{2} g ( {t}_{1} ) g ( {t}_{2} ) [ G ( {t}_{1} ) - G ( {t}_{2} ) ] [ {\hat{V}}_{j} ( {t}_{1} ) {\hat{V}}_{j} ( {t}_{2} ) + {\hat{V}}_{j} ( {t}_{2} ) {\hat{V}}_{j} ( {t}_{1} ) ] , \qquad ( 137 )$$

$${\hat{T}}_{110} = ( - \frac{2}{3} ) {\int }_{0}^{τ} {dt}_{1} {\int }_{0}^{{t}_{1}} {dt}_{2} g ( {t}_{1} ) g ( {t}_{2} ) G ( {t}_{1} ) {\sum }_{j} [ {\hat{V}}_{j} ( {t}_{1} ) {\hat{V}}_{j} ( {t}_{2} ) + {\hat{V}}_{j} ( {t}_{2} ) {\hat{V}}_{j} ( {t}_{1} ) ] {\hat{σ}}_{y}^{( j )} + ( \frac{4}{3} ) Φ [ η , g ] [ {\hat{σ}}_{x}^{( 1 )} {\hat{σ}}_{z}^{( 2 )} + {\hat{σ}}_{x}^{( 2 )} {\hat{σ}}_{z}^{( 1 )} ] , \qquad ( 138 )$$

$${\hat{T}}_{200} = 0. \qquad ( 139 )$$

Commutators \hat{T}ⱼₖₗ˜η³:

$${\hat{T}}_{003} = ( - \frac{1}{9} ) {\sum }_{j} \{ {\int }_{0}^{τ} g ( t ) {G}^{2} ( t ) {\hat{V}}_{j}^{3} ( t ) dt \} {\hat{σ}}_{x}^{( j )} , \qquad ( 140 )$$

$${\hat{T}}_{012} = ( \frac{1}{6} ) {\sum }_{k} {\hat{σ}}_{x}^{( k )} {\int }_{0}^{τ} {dt}_{1} {\int }_{0}^{{t}_{1}} {dt}_{2} g ( {t}_{1} ) g ( {t}_{2} ) \{ G ( {t}_{2} ) [ {\hat{V}}_{k} ( {t}_{2} ) {\hat{V}}_{k}^{2} ( {t}_{1} ) + {\hat{V}}_{k}^{2} ( {t}_{1} ) {\hat{V}}_{k} ( {t}_{2} ) ] - G ( {t}_{1} ) [ {\hat{V}}_{k} ( {t}_{1} ) {\hat{V}}_{k}^{2} ( {t}_{2} ) + {\hat{V}}_{k}^{2} ( {t}_{2} ) {\hat{V}}_{k} ( {t}_{1} ) ] \} - ( \frac{2}{3} ) {\sum }_{p} {η}_{p}^{1} {η}_{p}^{2} {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] \{ [ G ( {t}_{2} ) {\hat{V}}_{1} ( {t}_{1} ) + G ( {t}_{1} ) {\hat{V}}_{1} ( {t}_{2} ) ] {\hat{σ}}_{y}^{( 1 )} {\hat{σ}}_{z}^{( 2 )} + [ G ( {t}_{2} ) {\hat{V}}_{2} ( {t}_{1} ) + G ( {t}_{1} ) {\hat{V}}_{2} ( {t}_{2} ) ] {\hat{σ}}_{y}^{( 2 )} {\hat{σ}}_{z}^{( 1 )} \} , \qquad ( 141 )$$

$${\hat{T}}_{021} = ( \frac{1}{3} ) {\sum }_{k} {\hat{σ}}_{x}^{( k )} {\int }_{0}^{τ} {dt}_{1} {\int }_{0}^{{t}_{1}} {dt}_{2} g ( {t}_{1} ) g ( {t}_{2} ) G ( {t}_{1} ) [ {\hat{V}}_{k}^{2} ( {t}_{1} ) {\hat{V}}_{k} ( {t}_{2} ) + {\hat{V}}_{k} ( {t}_{2} ) {\hat{V}}_{k}^{2} ( {t}_{1} ) ] - ( \frac{2}{3} ) {\sum }_{p} {η}_{p}^{1} {η}_{p}^{2} {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] \{ [ G ( {t}_{2} ) {\hat{V}}_{1} ( {t}_{2} ) + G ( {t}_{1} ) {\hat{V}}_{1} ( {t}_{1} ) ] {\hat{σ}}_{y}^{( 1 )} {\hat{σ}}_{z}^{( 2 )} + [ G ( {t}_{2} ) {\hat{V}}_{2} ( {t}_{2} ) + G ( {t}_{1} ) {\hat{V}}_{2} ( {t}_{1} ) ] {\hat{σ}}_{y}^{( 2 )} {\hat{σ}}_{z}^{( 1 )} \} , \qquad ( 142 )$$

$${\hat{T}}_{030} = ( - \frac{2}{9} ) {\sum }_{j = 1 , 2} {\hat{σ}}_{x}^{( j )} {\int }_{0}^{τ} g ( t ) {G}^{2} ( t ) {\hat{V}}_{j}^{3} ( t ) dt , \qquad ( 143 )$$

$${\hat{T}}_{102} = 0 , \qquad ( 144 )$$

$${\hat{T}}_{111} = 0 , \qquad ( 145 )$$

$${\hat{T}}_{120} = 0 , \qquad ( 146 )$$

$${\hat{T}}_{021} = ( - \frac{1}{6} ) {\sum }_{j} {\hat{σ}}_{x}^{( j )} {\int }_{0}^{τ} {dt}_{1} {\int }_{0}^{{t}_{1}} {dt}_{2} g ( {t}_{1} ) g ( {t}_{2} ) [ G ( {t}_{1} ) - G ( {t}_{2} ) ] \{ {\hat{V}}_{j}^{2} ( {t}_{1} ) {\hat{V}}_{j} ( {t}_{2} ) + {\hat{V}}_{j} ( {t}_{2} ) {\hat{V}}_{j}^{2} ( {t}_{1} ) + {\hat{V}}_{j}^{2} ( {t}_{2} ) {\hat{V}}_{j} ( {t}_{1} ) + {\hat{V}}_{j} ( {t}_{1} ) {\hat{V}}_{j}^{2} ( {t}_{2} ) \} + ( \frac{2}{3} ) {\sum }_{p , j \neq k} {\hat{σ}}_{y}^{( j )} {\hat{σ}}_{z}^{( k )} {η}_{p}^{j} {η}_{p}^{k} {\int }_{0}^{τ} {dt}_{1} {\int }_{0}^{{t}_{1}} {dt}_{2} g ( {t}_{1} ) g ( {t}_{2} ) [ G ( {t}_{1} ) - G ( {t}_{2} ) ] sin [ {ω}_{p} ( {t}_{1} - {t}_{2} ) ] {\hat{[ V}}_{j} ( {t}_{1} ) - {\hat{V}}_{j} ( {t}_{2} ) ] , \qquad ( 147 )$$

$${\hat{T}}_{210} = ( \frac{1}{6} ) {\sum }_{j} {\hat{σ}}_{x}^{( j )} {\int }_{0}^{τ} {dt}_{1} {\int }_{0}^{{t}_{1}} {dt}_{2} g ( {t}_{1} ) g ( {t}_{2} ) \{ G ( {t}_{2} ) [ {\hat{V}}_{j}^{2} ( {t}_{1} ) {\hat{V}}_{j} ( {t}_{2} ) + {\hat{V}}_{j} ( {t}_{2} ) {\hat{V}}_{j}^{2} ( {t}_{1} ) ] - G ( {t}_{1} ) [ {\hat{V}}_{j}^{2} ( {t}_{2} ) {\hat{V}}_{j} ( {t}_{1} ) + {\hat{V}}_{j} ( {t}_{1} ) {\hat{V}}_{j}^{2} ( {t}_{2} ) ] \} - ( \frac{2}{3} ) {\sum }_{p , j \neq k} {\hat{σ}}_{y}^{( j )} {\hat{σ}}_{z}^{( k )} {η}_{p}^{j} {η}_{p}^{k} {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] [ G ( {t}_{2} ) {\hat{V}}_{j} ( {t}_{1} ) + G ( {t}_{1} ) {\hat{V}}_{j} ( {t}_{2} ) ] , \qquad ( 148 )$$

$${\hat{T}}_{300} = 0. \qquad ( 149 )$$

Commutators \hat{T}ⱼₖₗ˜η⁴:

$${\hat{T}}_{004} = 0 , \qquad ( 150 )$$

$${\hat{T}}_{013} = ( - \frac{1}{3} ) [ {\hat{σ}}_{x}^{( 1 )} {\hat{σ}}_{z}^{( 2 )} + {\hat{σ}}_{x}^{( 2 )} {\hat{σ}}_{z}^{( 1 )} ] {\sum }_{p , j = 1 , 2} {η}_{p}^{1} {η}_{p}^{2} {\int }_{0}^{τ} {dt}_{1} {\int }_{0}^{{t}_{1}} {dt}_{2} g ( {t}_{1} ) g ( {t}_{2} ) sin [ {ω}_{p} ( {t}_{1} - {t}_{2} ) ] [ G ( {t}_{1} ) {\hat{V}}_{j}^{2} ( {t}_{2} ) + G ( {t}_{2} ) {\hat{V}}_{j}^{2} ( {t}_{1} ) ] , \qquad ( 151 )$$

$${\hat{T}}_{022} = 0 \qquad ( 152 )$$

$${\hat{T}}_{031} = ( - \frac{2}{3} ) [ {\hat{σ}}_{x}^{( 1 )} {\hat{σ}}_{z}^{( 2 )} + {\hat{σ}}_{x}^{( 2 )} {\hat{σ}}_{z}^{( 1 )} ] {\sum }_{p , j = 1 , 2} {η}_{p}^{1} {η}_{p}^{2} {\int }_{0}^{τ} {dt}_{1} {\int }_{0}^{{t}_{1}} {dt}_{2} g ( {t}_{1} ) g ( {t}_{2} ) G ( {t}_{1} ) sin [ {ω}_{p} ( {t}_{1} - {t}_{2} ) ] {\hat{V}}_{j}^{2} ( {t}_{1} ) , \qquad ( 153 )$$

$${\hat{T}}_{040} = 0 \qquad ( 154 )$$

$${\hat{T}}_{103} = {\int }_{0}^{τ} {dt}_{1} {\int }_{0}^{{t}_{1}} {dt}_{2} g ( {t}_{1} ) g ( {t}_{2} ) [ G ( {t}_{1} ) - G ( {t}_{2} ) ] \{ ( \frac{1}{18} ) {\sum }_{j = 1 , 2} {\hat{σ}}_{y}^{( j )} [ {\hat{V}}_{j} ( {t}_{1} ) {\hat{V}}_{j}^{3} ( {t}_{2} ) + {\hat{V}}_{j}^{3} ( {t}_{2} ) {\hat{V}}_{j} ( {t}_{1} ) + {\hat{V}}_{j} ( {t}_{2} ) {\hat{V}}_{j}^{3} ( {t}_{1} ) + {\hat{V}}_{j}^{3} ( {t}_{1} ) {\hat{V}}_{j} ( {t}_{2} ) ] + ( \frac{1}{3} ) {\sum }_{j \neq k} {\hat{σ}}_{x}^{( j )} {\hat{σ}}_{z}^{( k )} {\sum }_{p} {η}_{p}^{j} {η}_{p}^{k} [ {\hat{V}}_{k}^{2} ( {t}_{2} ) - {\hat{V}}_{k}^{2} ( {t}_{1} ) ] sin [ {ω}_{p} ( {t}_{1} - {t}_{2} ) ] \} , \qquad ( 155 )$$

$${\hat{T}}_{112} = ( \frac{1}{6} ) {\int }_{0}^{τ} {dt}_{1} {\int }_{0}^{{t}_{1}} {dt}_{2} {\int }_{0}^{{t}_{2}} {dt}_{3} g ( {t}_{1} ) g ( {t}_{2} ) g ( {t}_{3} ) \{ ( - \frac{1}{2} ) {\sum }_{j} {\hat{σ}}_{y}^{( j )} \{ {\hat{V}}_{j} ( {t}_{1} ) [ {\hat{V}}_{j} ( {t}_{2} ) {\hat{V}}_{j}^{2} ( {t}_{3} ) + {\hat{V}}_{j}^{2} ( {t}_{3} ) {\hat{V}}_{j} ( {t}_{2} ) ] + [ {\hat{V}}_{j} ( {t}_{2} ) {\hat{V}}_{j}^{2} ( {t}_{3} ) + {\hat{V}}_{j}^{2} ( {t}_{3} ) {\hat{V}}_{j} ( {t}_{2} ) ] {\hat{V}}_{j} ( {t}_{1} ) + {\hat{V}}_{j} ( {t}_{3} ) [ {\hat{V}}_{j} ( {t}_{2} ) {\hat{V}}_{j}^{2} ( {t}_{1} ) + {\hat{V}}_{j}^{2} ( {t}_{1} ) {\hat{V}}_{j} ( {t}_{2} ) ] + [ {\hat{V}}_{j} ( {t}_{2} ) {\hat{V}}_{j}^{2} ( {t}_{1} ) + {\hat{V}}_{j}^{2} ( {t}_{1} ) {\hat{V}}_{j} ( {t}_{2} ) ] {\hat{V}}_{j} ( {t}_{3} ) \} - 2 {\sum }_{p , j \neq k} {\hat{σ}}_{x}^{( j )} {\hat{σ}}_{z}^{( k )} {η}_{p}^{j} {η}_{p}^{k} \{ {\hat{V}}_{k}^{2} ( {t}_{3} ) sin [ {ω}_{p} ( {t}_{1} - {t}_{2} ) ] - {V}_{k}^{2} ( {t}_{1} ) sin [ {ω}_{p} ( {t}_{2} - {t}_{3} ) ] + [ {\hat{V}}_{k} ( {t}_{2} ) {\hat{V}}_{k} ( {t}_{3} ) + {\hat{V}}_{k} ( {t}_{3} ) {\hat{V}}_{k} ( {t}_{2} ) ] sin [ {ω}_{p} ( {t}_{1} - {t}_{3} ) ] - [ {\hat{V}}_{k} ( {t}_{2} ) {\hat{V}}_{k} ( {t}_{1} ) + {\hat{V}}_{k} ( {t}_{1} ) {\hat{V}}_{k} ( {t}_{1} ) {\hat{V}}_{k} ( {t}_{2} ) ] sin [ {ω}_{p} ( {t}_{1} - {t}_{3} ) ] \} + 4 {\sum }_{pq} {η}_{p}^{1} {η}_{p}^{2} {η}_{q}^{1} {η}_{q}^{2} ( {\hat{σ}}_{y}^{( 1 )} + {\hat{σ}}_{y}^{( 2 )} ) sin [ {ω}_{q} ( {t}_{1} - {t}_{3} ) ] \{ sin [ {ω}_{p} ( {t}_{2} - {t}_{3} ) ] - sin [ {ω}_{p} ( {t}_{2} - {t}_{1} ) ] \} - 2 {\sum }_{p} {η}_{p}^{1} {η}_{p}^{2} {\hat{σ}}_{x}^{( 1 )} {\hat{σ}}_{z}^{( 2 )} [ {\hat{V}}_{2} ( {t}_{1} ) {\hat{V}}_{2} ( {t}_{3} ) + {\hat{V}}_{2} ( {t}_{3} ) {\hat{V}}_{2} ( {t}_{1} ) ] \{ sin [ {ω}_{p} ( {t}_{2} - {t}_{3} ) ] + \{ sin [ {ω}_{p} ( {t}_{2} - {t}_{1} ) ] \} \} , \qquad ( 156 )$$

$${\hat{T}}_{121} = ( - \frac{1}{12} ) {\int }_{0}^{τ} {dt}_{1} {\int }_{0}^{{t}_{1}} {dt}_{2} {\int }_{0}^{{t}_{2}} {dt}_{3} g ( {t}_{1} ) g ( {t}_{2} ) g ( {t}_{3} ) {\sum }_{jkl} \{ 2 [ {\hat{V}}_{j} ( {t}_{1} ) {\hat{V}}_{k}^{2} ( {t}_{2} ) {\hat{V}}_{l} ( {t}_{3} ) + {\hat{V}}_{j} ( {t}_{3} ) {\hat{V}}_{k}^{2} ( {t}_{2} ) {\hat{V}}_{l} ( {t}_{1} ) ] {\hat{σ}}_{x}^{( j )} {\hat{σ}}_{y}^{( k )} {\hat{σ}}_{x}^{( l )} - [ {\hat{V}}_{j} ( {t}_{1} ) {\hat{V}}_{k} ( {t}_{3} ) {\hat{V}}_{l}^{2} ( {t}_{2} ) + {\hat{V}}_{j} ( {t}_{3} ) {\hat{V}}_{k} ( {t}_{1} ) {\hat{V}}_{l}^{2} ( {t}_{2} ) ] {\hat{σ}}_{x}^{( j )} {\hat{σ}}_{x}^{( k )} {\hat{σ}}_{y}^{( l )} - [ {\hat{V}}_{j}^{2} ( {t}_{2} ) {\hat{V}}_{k} ( {t}_{3} ) {\hat{V}}_{l} ( {t}_{1} ) + {\hat{V}}_{j}^{2} ( {t}_{2} ) {\hat{V}}_{k} ( {t}_{1} ) {\hat{V}}_{l} ( {t}_{3} ) ] {\hat{σ}}_{y}^{( j )} {\hat{σ}}_{x}^{( k )} {\hat{σ}}_{x}^{( l )} \} , \qquad ( 157 )$$

$${\hat{T}}_{130} = ( \frac{1}{9} ) {\int }_{0}^{τ} {dt}_{1} {\int }_{0}^{{t}_{1}} {dt}_{2} g ( {t}_{1} ) g ( {t}_{2} ) G ( {t}_{1} ) \{ {\sum }_{j = 1 , 2} {\hat{σ}}_{y}^{( j )} [ {\hat{V}}_{j} ( {t}_{2} ) {\hat{V}}_{j}^{3} ( {t}_{1} ) + {\hat{V}}_{j}^{3} ( {t}_{1} ) {\hat{V}}_{j} ( {t}_{2} ) ] \} - ( \frac{2}{3} ) {\int }_{0}^{τ} {dt}_{1} {\int }_{0}^{{t}_{1}} {dt}_{2} g ( {t}_{1} ) g ( {t}_{2} ) {\sum }_{\begin{matrix}j , k = 1 , 2 \\ j \neq k\end{matrix}} {\sum }_{p = 1}^{N} {η}_{p}^{j} {η}_{p}^{k} {σ}_{x}^{j} {σ}_{z}^{k} G ( {t}_{1} ) {\hat{V}}_{k}^{2} ( {t}_{1} ) sin [ {ω}_{p} ( {t}_{1} - {t}_{2} ) ] , \qquad ( 158 )$$

$${\hat{T}}_{202} = 0 , \qquad ( 159 )$$

$${\hat{T}}_{211} = ( \frac{4}{3} ) {\sum }_{p , k \neq j} {η}_{p}^{1} {η}_{p}^{2} {\hat{σ}}_{z}^{( j )} {\hat{σ}}_{x}^{( k )} {\int }_{0}^{τ} {dt}_{1} {\int }_{0}^{{t}_{1}} {dt}_{2} {\int }_{0}^{{t}_{2}} {dt}_{3} g ( {t}_{1} ) g ( {t}_{2} ) g ( {t}_{3} ) {\hat{V}}_{j}^{2} ( {t}_{1} ) sin [ {ω}_{p} ( {t}_{2} - {t}_{3} ) ] , \qquad ( 160 )$$

1. A method of performing a two-qubit gate operation, comprising:
computing, by a classical computer, a control pulse to be applied to a pair of trapped ions in a plurality of trapped ions in a quantum processor, each of the plurality of trapped ions having two frequency-separated states defining a qubit, wherein computing the control pulse comprises:
computing a pulse function of the control pulse based on a phase-space closure condition and an auxiliary condition; and
computing the pulse function of the control pulse further based on a gate angle condition; and
applying, by a system controller, the control pulse, having the computed pulse function, to the pair of trapped ions.

2. The method of claim 1, wherein the computing of the pulse function based on the phase-space closure condition and the auxiliary condition comprises computing Fourier coefficients of the pulse function of the control pulse by solving a set of linear equations with respect to the Fourier coefficients.

3. The method of claim 2, wherein the phase-space closure condition requires the pair of trapped ions that are excited by a delivery of the control pulse return to their initial motional state.

4. The method of claim 3, wherein the auxiliary condition implies the vanishing of the Φ functional.

5. The method of claim 1, further comprising:
prior to the application of the control pulse, calibrating the pulse function of the control pulse by multiplying the pulse function by a calibration factor.

6. The method of claim 5, wherein the calibration factor is based on a gate angle error and a target gate angle determined by the gate angle condition.

7. The method of claim 6, wherein the target gate angle is
$$\frac{π}{4} .$$

8. A quantum computing system, comprising:
a quantum processor comprising a plurality of trapped ions, wherein each of the trapped ions having two frequency-separated states defining a qubit;
a classical computer configured to:
compute a control pulse to be applied to a pair of trapped ions in the quantum processor, wherein computing the control pulse comprises:
computing a pulse function of the control pulse based on a phase-space closure condition and an auxiliary condition; and
computing the pulse function of the control pulse further based on a gate angle condition; and
a system controller configured to:
apply the control pulse, having the computed pulse function, to the pair of trapped ions.

9. The quantum computing system of claim 8, wherein the computing of the pulse function, based on the phase-space closure condition and the auxiliary condition, comprises computing Fourier coefficients of the pulse function of the control pulse by solving a set of linear equations with respect to the Fourier coefficients.

10. The quantum computing system of claim 9, wherein the phase-space closure condition requires the pair of trapped ions that are excited by a delivery of the control pulse return to their initial motional state.

11. The quantum computing system of claim 10, wherein the auxiliary condition causes the Φ functional to vanish.

12. The quantum computing system of claim 8, further comprising:
prior to the applying of the control pulse, calibrating the pulse function of the control pulse by multiplying the pulse function by a calibration factor.

13. The quantum computing system of claim 12, wherein the calibration factor is based on a gate angle error and a target gate angle determined by the gate angle condition.

14. The quantum computing system of claim 13, wherein the target gate angle is
$$\frac{π}{4} .$$

15. A quantum computing system comprising non-volatile memory having a number of instructions stored therein which, when executed by one or more processors, causes the quantum computing system to perform operations comprising:
computing, by a classical computer, a control pulse to be applied to a pair of trapped ions in a plurality of trapped ions in a quantum processor, each of the plurality of trapped ions having two frequency-separated states defining a qubit, wherein computing the control pulse comprises:
computing a pulse function of the control pulse based on a phase-space closure condition and an auxiliary condition; and
computing the pulse function of the control pulse further based on the gate angle condition; and
applying, by a system controller, the control pulse, having the computed pulse function, to the pair of trapped ions.

16. The quantum computing system of claim 15, wherein the computing of the pulse function, based on the phase-space closure condition and the auxiliary condition, comprises computing Fourier coefficients of the pulse function of the control pulse by solving a set of linear equations with respect to the Fourier coefficients.

17. The quantum computing system of claim 16, wherein the phase-space closure condition requires the pair of trapped ions that are excited by a delivery of the control pulse return to their initial motional state.

18. The quantum computing system of claim 17, wherein the auxiliary condition implies the vanishing of the Φ functional.

19. The quantum computing system of claim 15, further comprising:
prior to the applying of the control pulse, calibrating the pulse function of the control pulse by multiplying the pulse function by a calibration factor.

20. The quantum computing system of claim 19, wherein the calibration factor is based on a gate angle error and a target gate angle determined by the gate angle condition.
